(19) United States
(12) Patent Application Publication
(10) Pub. No.: US 2009/0208892 A1
(43) Pub. Date: Aug. 20, 2009

(54) TORTILLA OVEN

(75) Inventors: Austin J. Kozman, Dallas, TX (US); Jose G. Ramirez, Rio Medina, TX (US)

Correspondence Address: MICHAEL A. O'NEIL, P.C., 5949 SHERRY LANE, SUITE 820, DALLAS, TX, 75225, US

(73) Assignee: STEWART SYSTEMS, INC., Plano, TX (US)

(21) Appl. No.: 12/369,615

(22) Filed: Feb. 11, 2009

Related U.S. Application Data
(63) Continuation-in-part of application No. 12/051,041, filed on Mar. 19, 2008.
(60) Provisional application No. 60/896,027, filed on Mar. 21, 2007.

(51) Int. Cl. A21B 1/28; F27B 9/24; A21B 1/48

(52) U.S. Cl. 432/146; 99/443 C; 99/447; 432/136; 432/149

(57) ABSTRACT

A tortilla oven comprises a housing which encloses upper, center, and lower conveyors. The lengths of the conveyors are individually monitored and adjusted. The interior of the housing is heated by a plurality of the individually regulated burners that extend through the conveyors. Ambient air is directed upwardly along the sides of the housing for temperature control.

### CROSS-REFERENCE TO RELATED APPLICATION

This application is a continuation-in-part patent application of U.S. patent application Ser. No. 12/051,041 filed Mar. 19, 2008, currently pending, which claims priority based on U.S. Provisional Patent Application No. 60/896,027 filed Mar. 21, 2007, the entire content of which is incorporated herein by reference.

### DESCRIPTION OF THE DRAWINGS

FIG. 1 is a perspective view of a tortilla oven comprising the present invention:

FIG. 2 is a top view of the tortilla oven of FIG. 1;

FIG. 3 is a left end view of the tortilla oven of FIG. 1;

FIG. 4 is a view similar to FIG. 1 showing the construction of the frame of the tortilla oven of FIG. 1;

FIG. 5 is a front view of the tortilla oven of FIG. 1 from which various doors have been removed in order to illustrate particular components of the invention;

FIG. 6 is a perspective view similar to FIG. 4 to which the input section and the discharge section of the tortilla oven have been added;

FIG. 7 is a perspective view of the input section of the tortilla oven;

FIG. 8 is a perspective view of the discharge section of the tortilla oven;

FIG. 9 is an exploded view of the discharge section of the tortilla oven;

FIG. 10A is a sectional view of the tortilla oven taken along the line 10A-10A in FIG. 2;

FIG. 10B is an illustration of a first chain tension monitoring device comprising the tortilla oven.

FIG. 10C is an illustration of a second chain tension monitoring device comprising the tortilla oven;

FIG. 10D is sectional view similar to FIG. 10A illustrating an alternative configuration of the tortilla oven;

FIG. 11 is a perspective view of a debris receiving drawer comprising the tortilla oven;

FIG. 12 is a perspective view illustrating the construction of a conveyor useful in the practice of the invention;

FIGS. 12A-12P inclusive illustrate the constructions of alternative conveyor constructions and components thereof useful in the practice of the invention;

FIG. 13 is top view illustrating the construction of the drive shafts of the tortilla oven;

FIG. 14 is a perspective view further illustrating the construction of the drive shaft of the tortilla oven;

FIG. 15 is a further illustration of the construction of the drive shafts of the tortilla oven;

FIG. 16 is an enlarged partial perspective view illustrating certain components of the drive shafts of the tortilla oven;

FIG. 17 is a partial perspective view further illustrating the construction of certain components of the drive shafts of the tortilla oven;

FIG. 18 is an exploded view further illustrating the construction of the drive shafts of the tortilla oven;

FIG. 19 is an illustration of one end of one of the drive shafts comprising the tortilla oven;

FIG. 20 is sectional view illustrating a component of the drive shaft illustrated in FIG. 19;

FIG. 21 is a side view of the tortilla oven illustrating the construction and operation of the burner assemblies thereof;

FIG. 22 is a top view further illustrating the construction and operation of the burner assemblies of the tortilla oven;

FIG. 23 is perspective view further illustrating the construction and operation of the burner assemblies of the tortilla oven;

FIG. 23A is a side view illustrating the construction and operation of alternate burner assemblies useful in the practice of the invention;

FIG. 24 is an illustration of a temperature control system and of an exhaust gas removal system comprising the tortilla oven;

FIG. 25 is an illustration of a chain temperature monitoring system comprising the tortilla oven;

FIG. 26 is a flow chart illustrating the operation of the chain temperature monitoring system of FIG. 25;

FIG. 27 is a perspective view illustrating an alternative chain temperature monitoring system comprising the tortilla oven;

FIG. 28 is a perspective view further illustrating the alternative chain temperature monitoring system;

FIG. 29A is a perspective view of a lubrication system useful in the practice of the invention;

FIG. 29B is an enlargement of a portion of FIG. 29A;

FIG. 29C is an enlargement of a portion of FIG. 29A;

FIG. 29D is an enlargement of a portion of FIG. 29A;

FIG. 30 is a perspective view of a tiltable discharge conveyor useful in the practice of the invention showing the discharge conveyor in its operating configuration;

FIG. 30A is an illustration of the conveyor of FIG. 30 showing the conveyor in its tilted orientation;

FIG. 31 is a side view illustrating a complete tortilla manufacturing system incorporating the tortilla oven and discharge conveyor of the present invention;

FIG. 32A is an enlargement of a portion of FIG. 31; and

FIG. 32B is an enlarged partial top view of the tortilla manufacturing system of FIG. 31.

### DETAILED DESCRIPTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

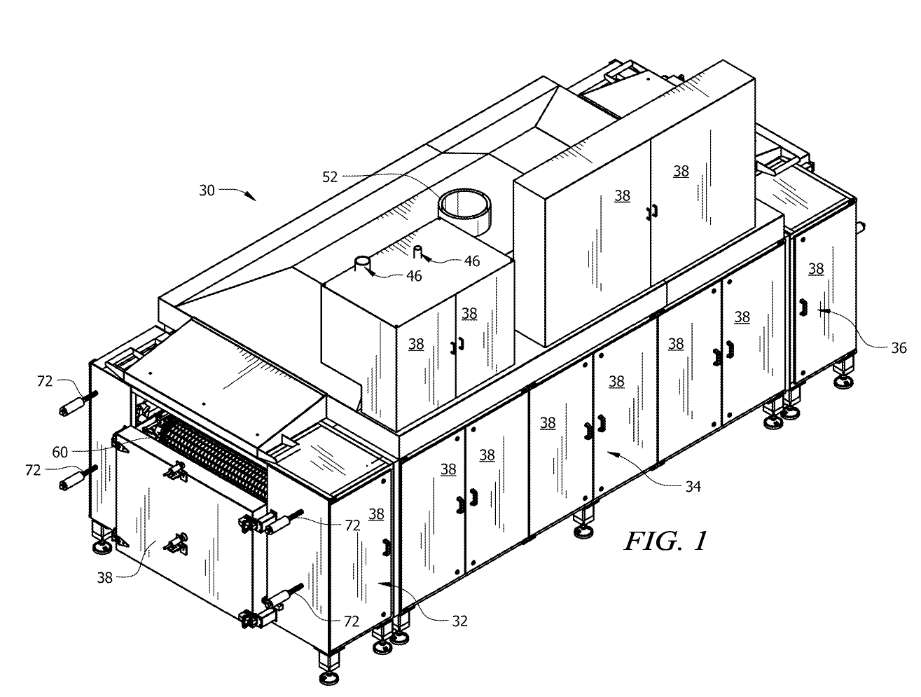

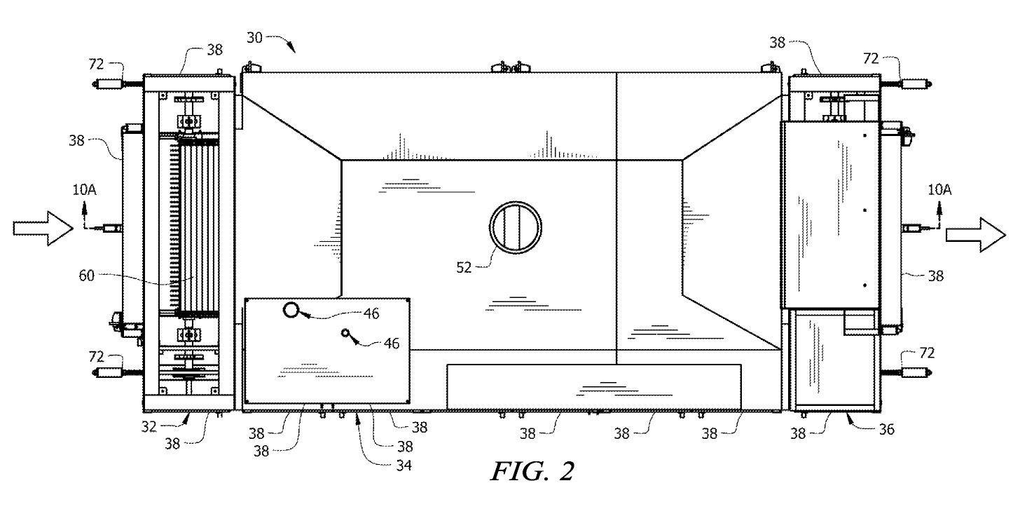

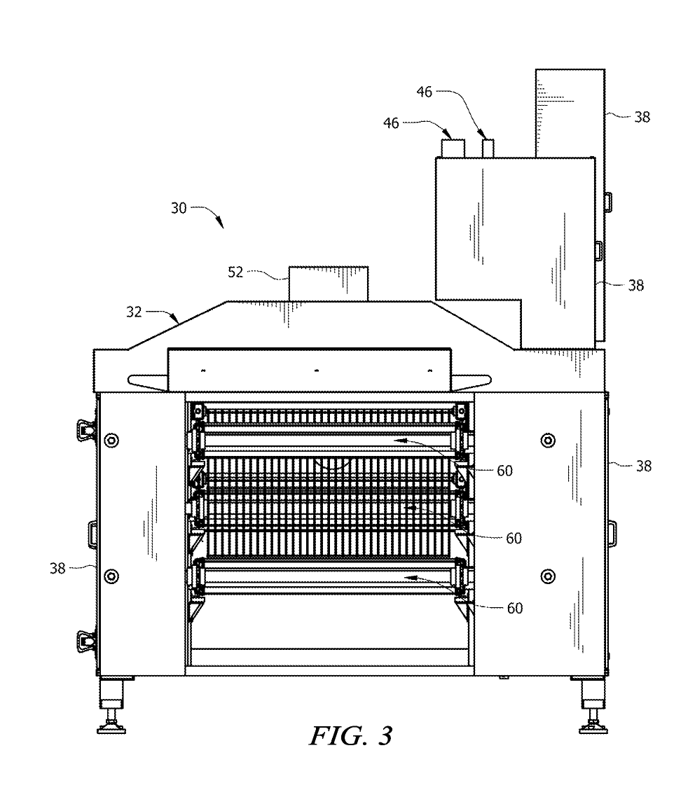

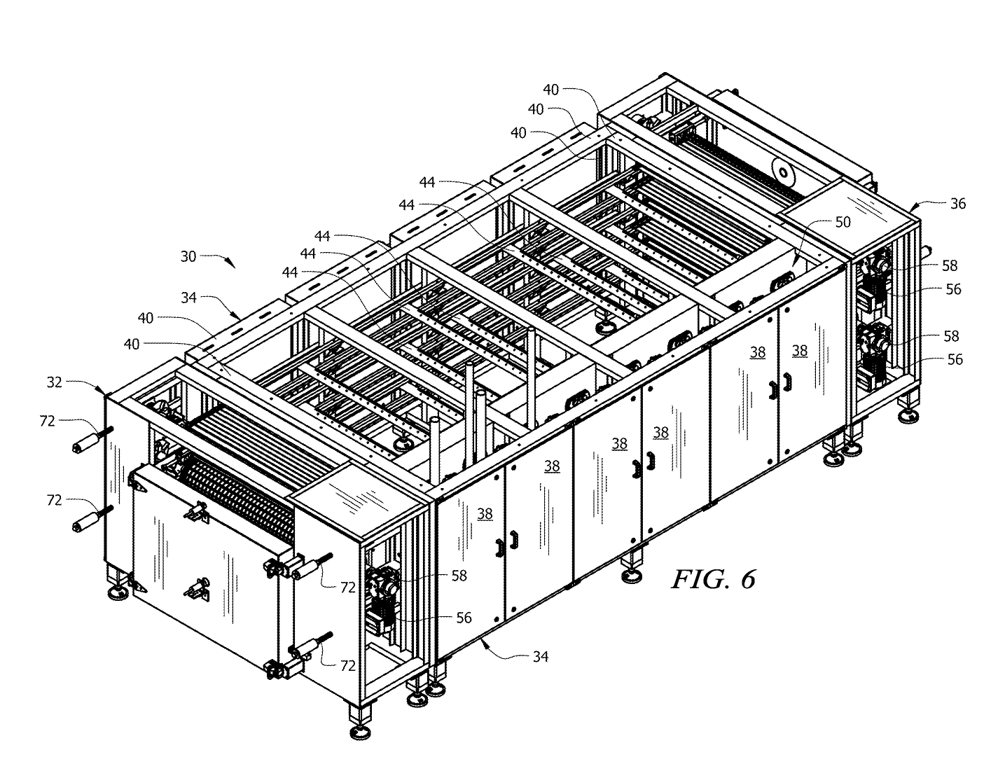

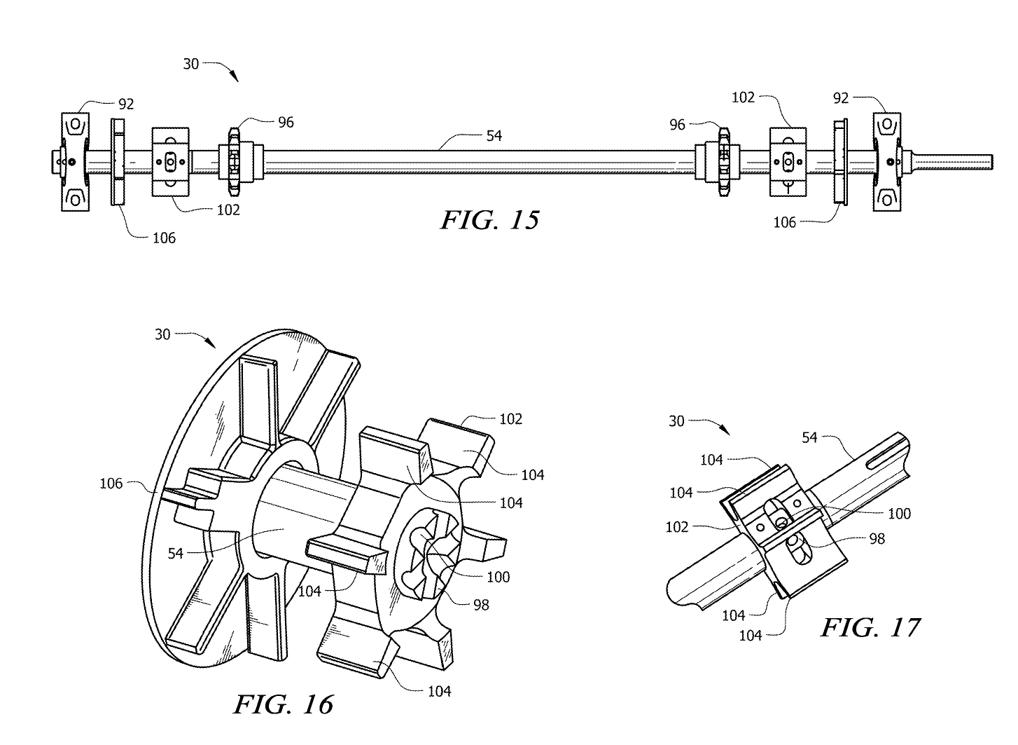

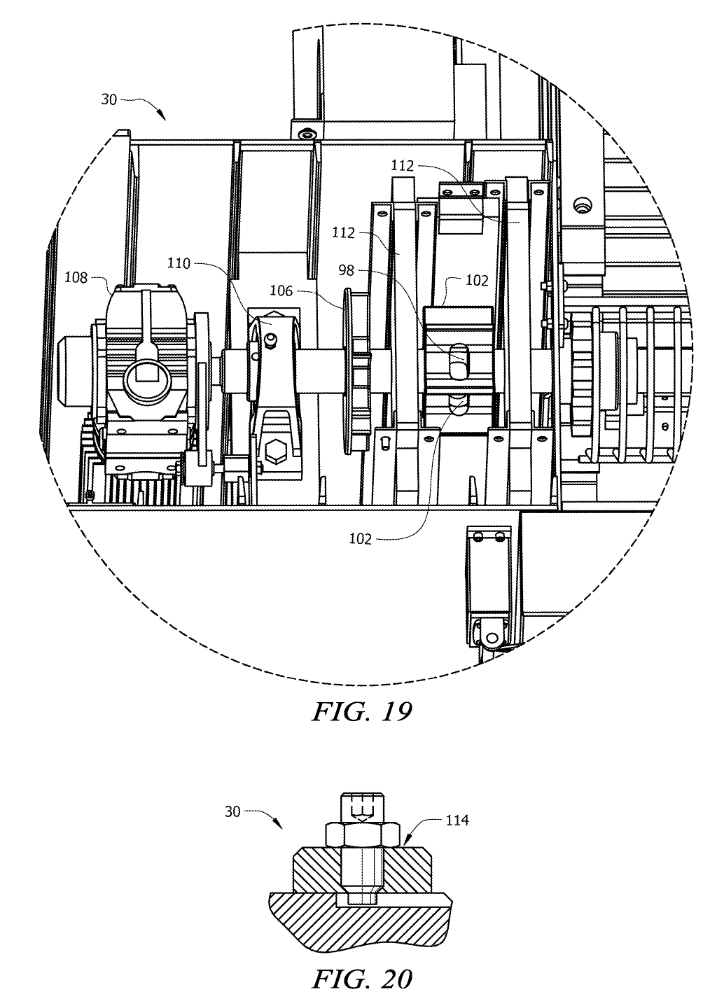

FIGS. 1-31 inclusive illustrate the construction and operation of a tortilla oven 30 comprising the present invention. Referring particularly to FIGS. 1-9 the tortilla oven 30 comprises an input section 32, a baking section 34, and a discharge section 36 which are normally secured one to another by appropriate fasteners including but not limited to quick disconnect fasteners. Each of the sections 32, 34, and 36 comprises a plurality of doors 38 which enclose and protect the component parts of the tortilla oven 30 while affording access thereto.

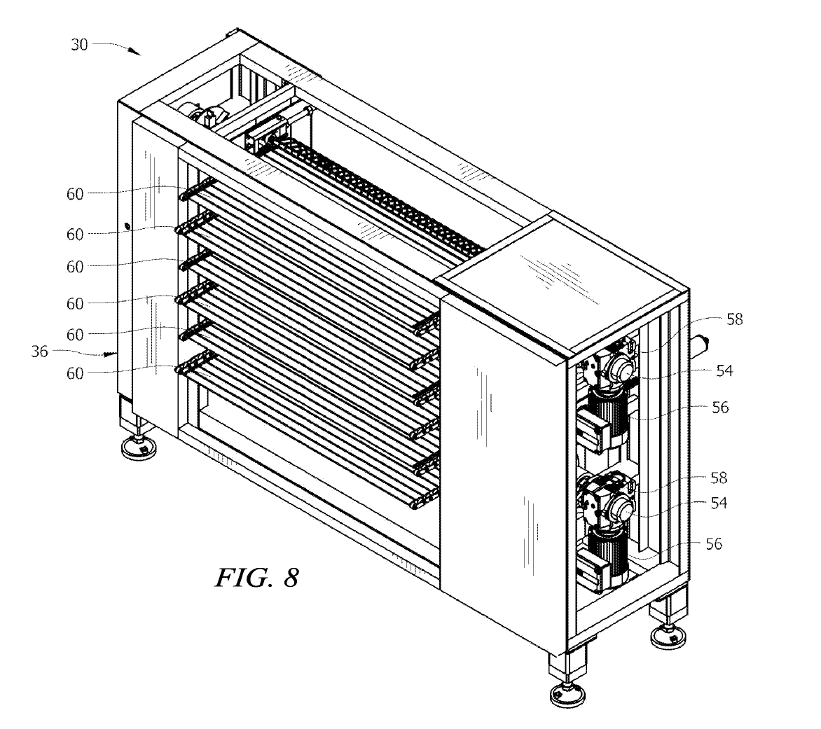

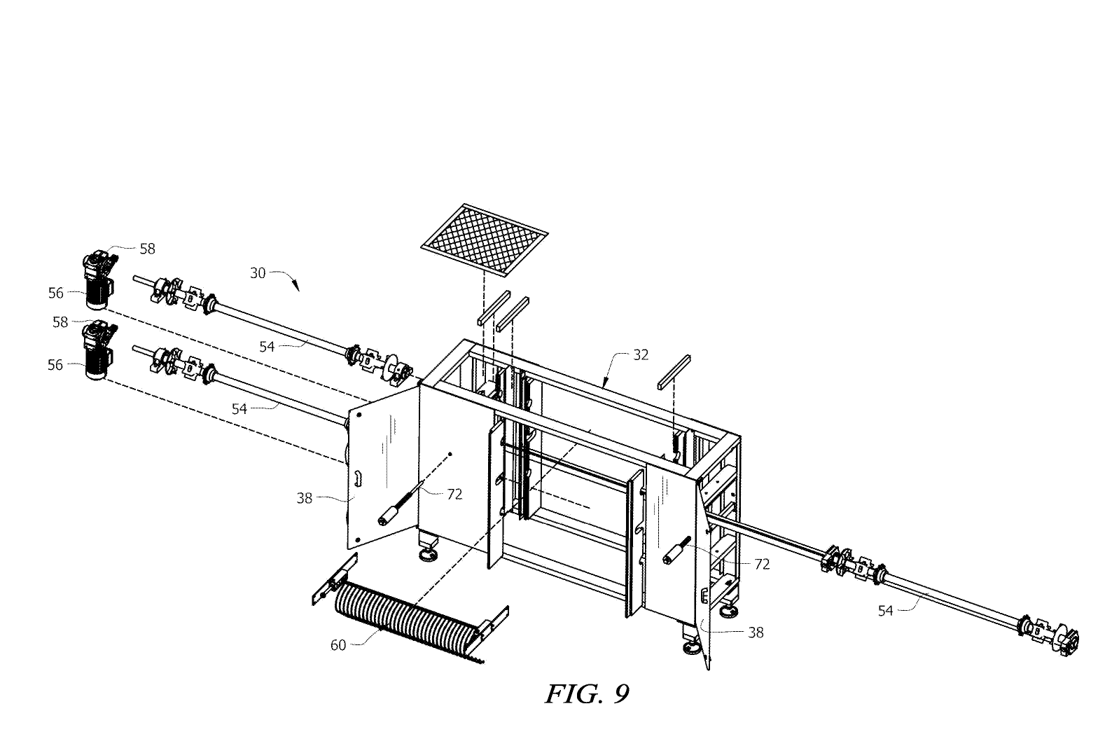

Alternatively, the baking section 34 can be comprised of smaller modules that attach together, which allows for future expansion and ease of transportation and installation of the tortilla oven 30. The smaller modules comprise quick disconnects for all mechanical, electrical, and plumbing connections. The smaller modules also provide for thermal expansion relative to one another as the tortilla oven 30 expands and contracts with temperature changes. The chain guiding tracks 42 and other components are manufactured from one solid piece running the length of the bake chamber and installed at start-up. The ability to disconnect the input and discharge sections is an advantage in that allows easier access and sanitation. Referring to FIG. 9, the drive shafts 54 are individually removable as needed for maintenance, and also for future length expansion of the tortilla oven if required.

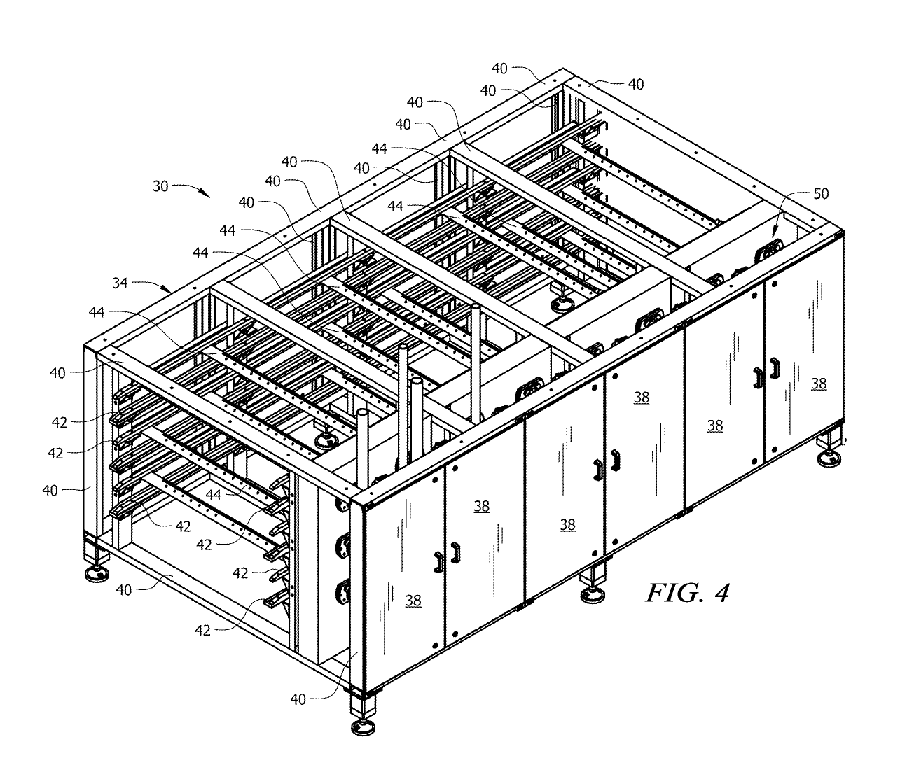

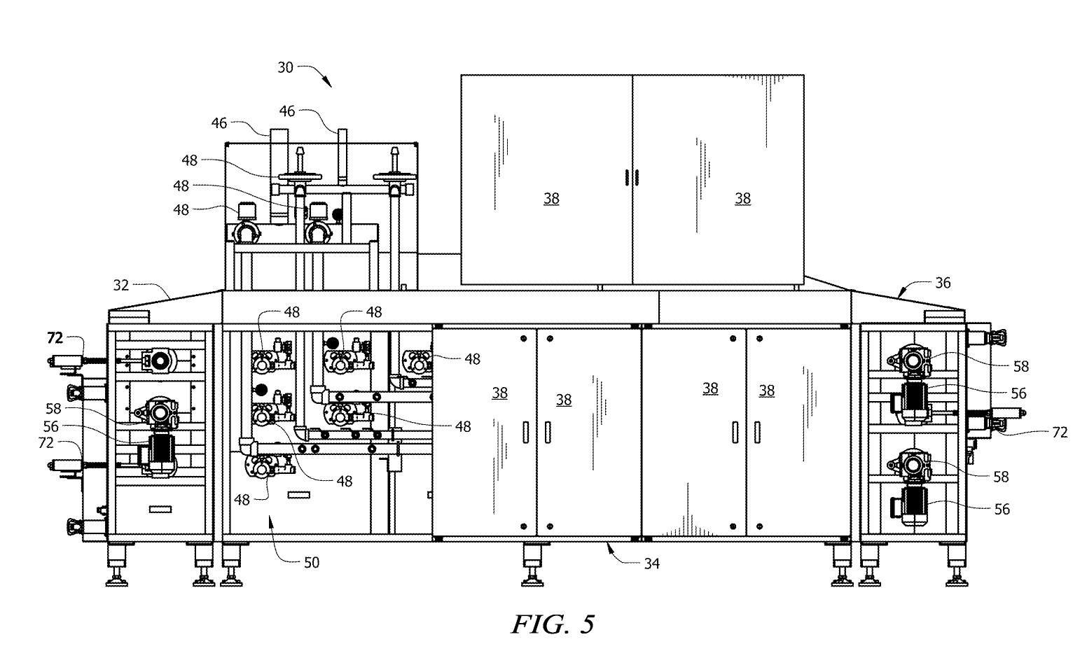

Referring particularly to FIGS. 4-6 inclusive, the construction of the baking section 34 of the tortilla oven 30 is shown in detail. The baking section 34 includes a plurality of structural components 40 which support a plurality of chain guiding tracks 42. The baking section 34 further comprises the plurality of burners 44. The burners 44 receive a mixture of a selected fuel, typically natural gas, and a selected oxidizer, typically air, which are directed into the baking section 34 through a plurality of pipes 46. As is best shown FIG. 5, the flow of the fuel and oxidizer into the burners 44 is controlled by a plurality of regulators 48. The regulators are situated in a compartment 50 which extends along one side of the baking section 34 and is accessible by opening the doors 38. The operation of the burners 44 results in gaseous products of combustion which are removed from the baking section 34 through one or more outlets 52 (FIGS. 1, 2, and 3).

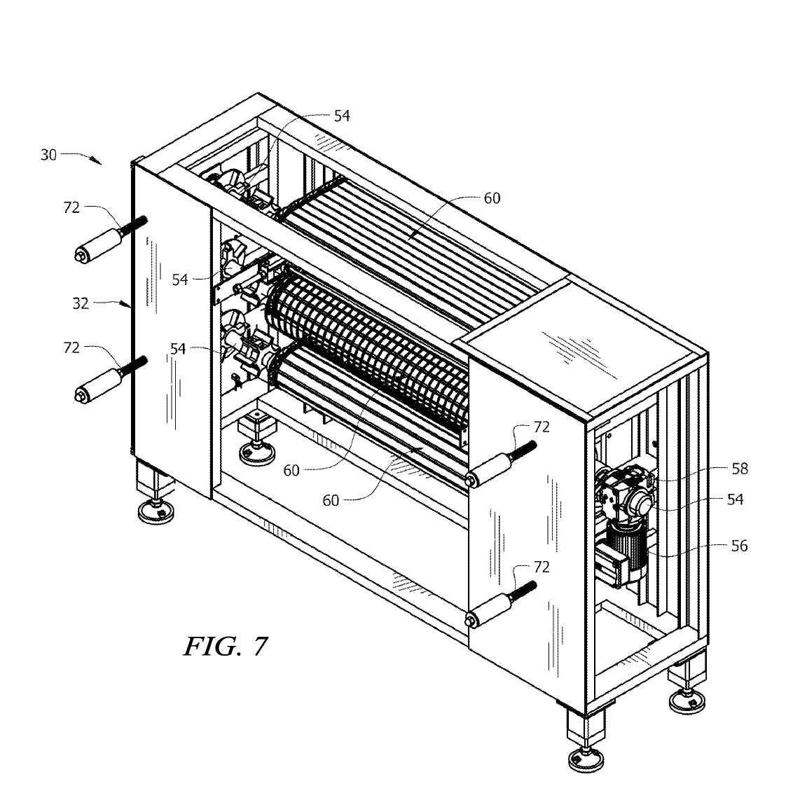

The inlet section 32 and the outlet section 36 of the tortilla oven 30 are illustrated in FIGS. 7 and 8, respectively. The inlet section 32 and the outlet section 36 each comprise a plurality of drive shafts 54. Each of the drive shafts 54 is driven by a drive motor 56 operating through a right angle gearbox 58. The drive shafts 54 define the paths of three chain conveyors 60 which transport tortillas through the tortilla oven 30.

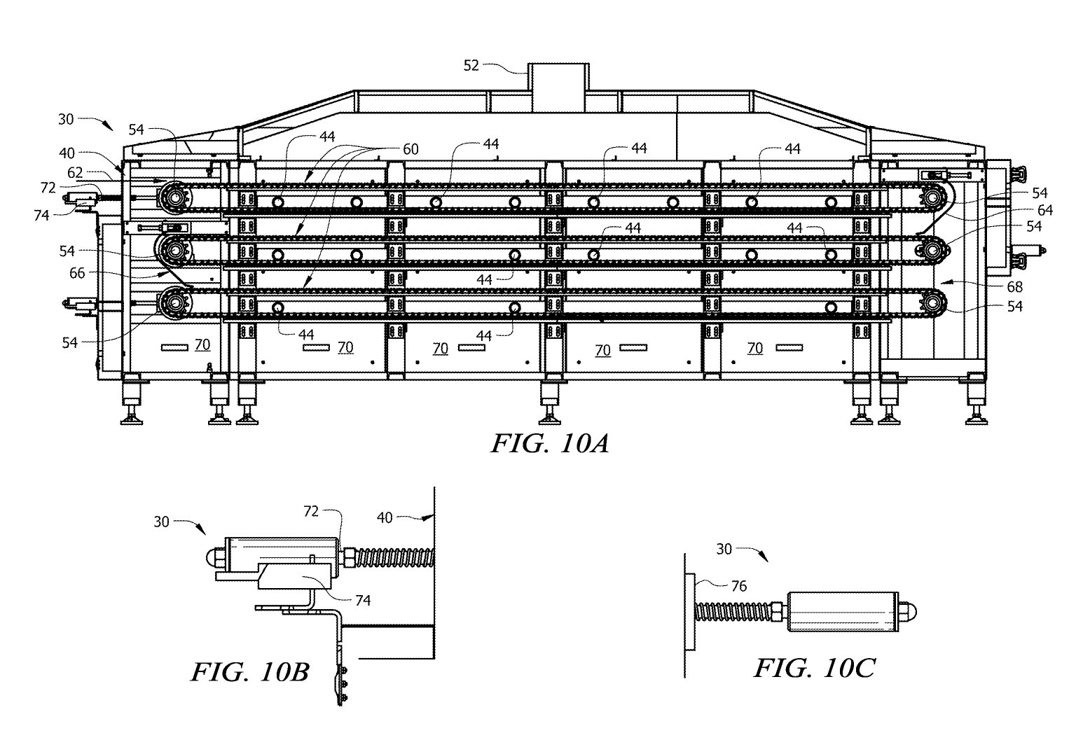

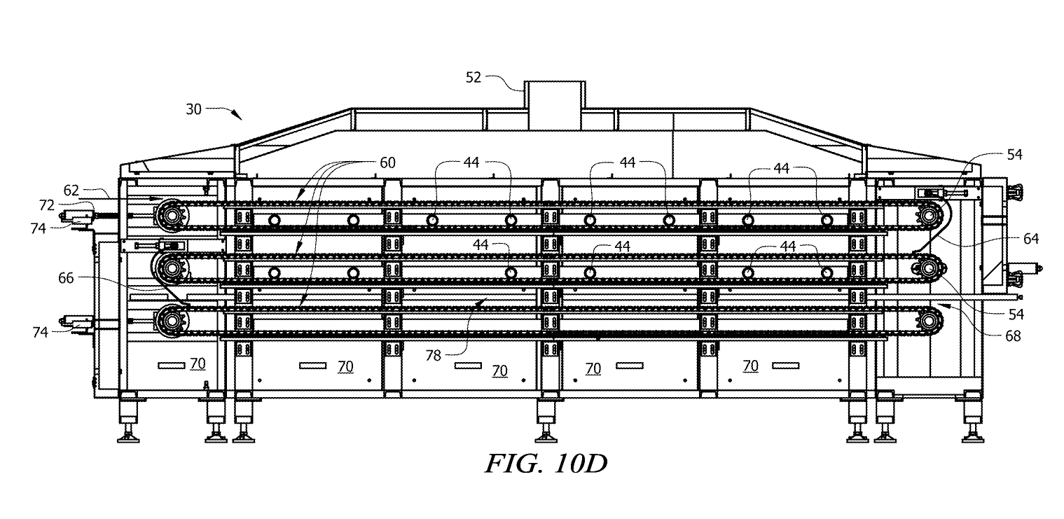

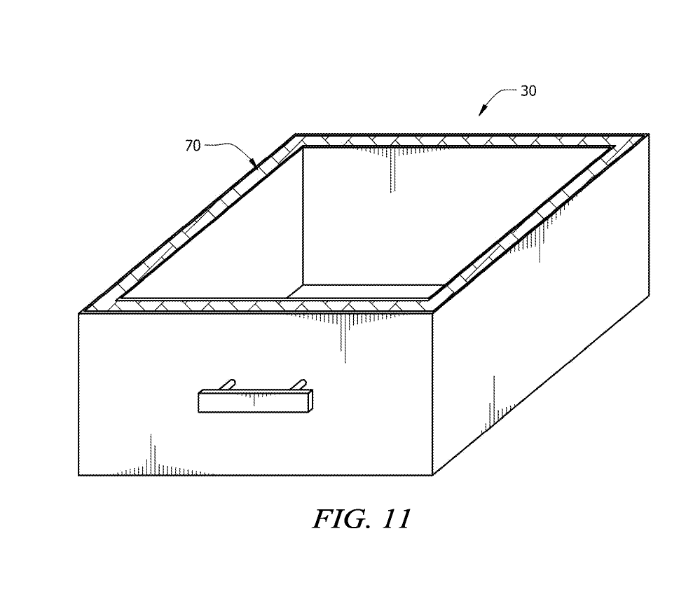

The constructed and operation of the tortilla oven 30 is further illustrated in FIGS. 10A, 10B, 10C, 10D, and 11. Uncooked tortillas are received in the tortilla oven 30 at location 62. The tortillas are transported from location 62 along a horizontal plane by the upper conveyor 60. When the tortillas have reached the end of the upper conveyor 60 they are directed onto the center conveyor 60 by a chute 64. The center conveyor transports the tortillas along a horizontal plane to the remote end thereof where the tortillas are discharged onto the lower conveyor 60 by a chute 66. The lower conveyor 60 transports the tortillas along a horizontal plane until the fully baked tortillas are ultimately discharged from the tortilla oven 30 at location 68. A plurality of drawers 70 are located just below the lower conveyor 60. The drawers 70 receive broken tortillas and other debris resulting from operation of the tortilla oven 30. As is best shown in FIG. 11 the drawers 70 are fully insulated thereby preventing heat loss from the tortilla oven 30 through the bottom thereof.

Referring simultaneously to FIGS. 10A and 10B a rod 72 is operably connected to each of the return shafts 54 comprising the conveyor 60 for movement therewith as the tension within the associated conveyor 60 increases or decreases. A sensor 74 monitors the positioning of the rod 72 relative to adjacent frame component 40 of the tortilla oven 30. When the positioning of the rod 72 moves beyond a predetermined limit the sensor 74 sends an alarm signal to the operator of the tortilla oven 30 whereupon the tension of the conveyor 60 associated with the sensor 74 that generated the alarm can be appropriately adjusted.

Referring to FIG. 10C, in lieu of the sensor 74 which measures displacement a load cell 76 can be employed to directly measure the force that is applied to a particular conveyor 60 during operation thereof. When the load cell 76 senses a force that is beyond a predetermined limit the operator of the tortilla oven 30 is notified so that appropriate adjustments to the operational parameters of the conveyor which triggered the signal from the load cell 76 can be made.

An alternative version of the tortilla oven 30 is illustrated in FIG. 10D. In accordance with the alternative version of the tortilla oven 30 a wall or floor 78 is positioned between the center conveyor 60 and the lower conveyor 60. Although the deployment of burners 44 between the upper and lower runs of the upper conveyor 60 and the upper and lower runs of the center conveyor 60 is the same as illustrated in FIG. 10A, the lower conveyor 60 of FIG. 10D is not provided with burners. The function of the wall 78 is to isolate the non-heated lower portion of the tortilla oven 30 from the heated upper portion thereof. Thus, in the operation of the embodiment of the tortilla oven 30 shown in FIG. 10D the lower conveyor 60 functions to begin the cooling of fully baked tortillas after they have made two passes through the tortilla oven 30 by means of the upper conveyor 60 and the center conveyor 60. Otherwise the construction and operation of the embodiment of the tortilla oven 30 illustrated in FIG. 10D is identical to that of the operation of the tortilla oven 30 illustrated in FIG. 10A and described hereinabove in conjunction therewith.

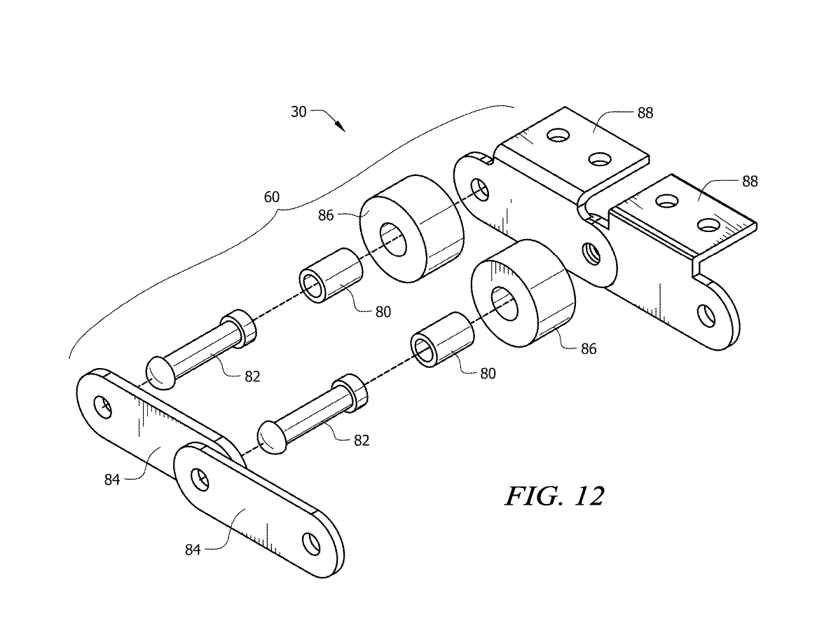

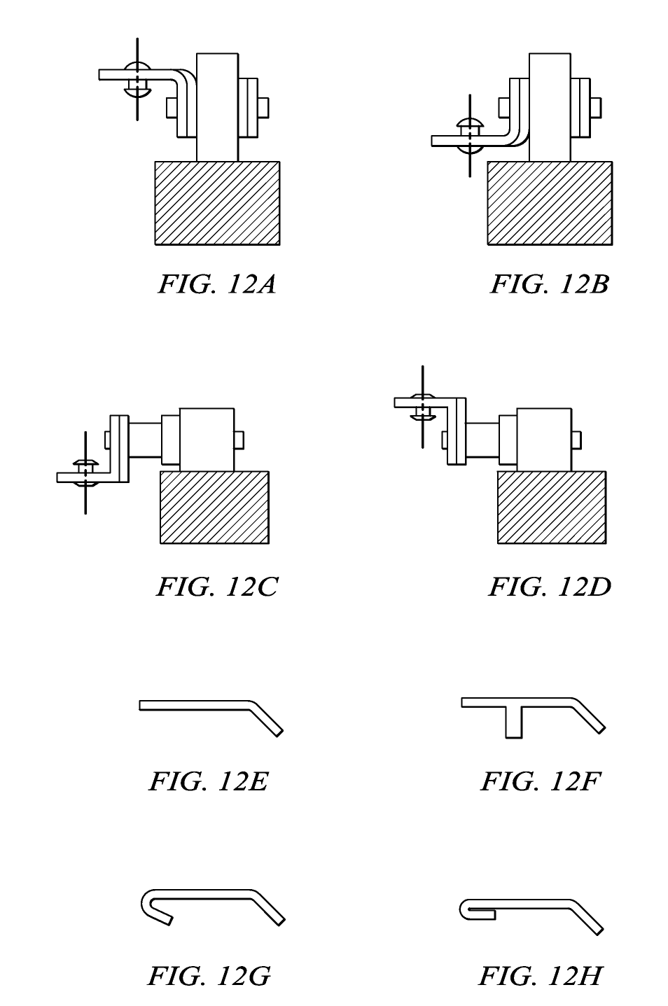

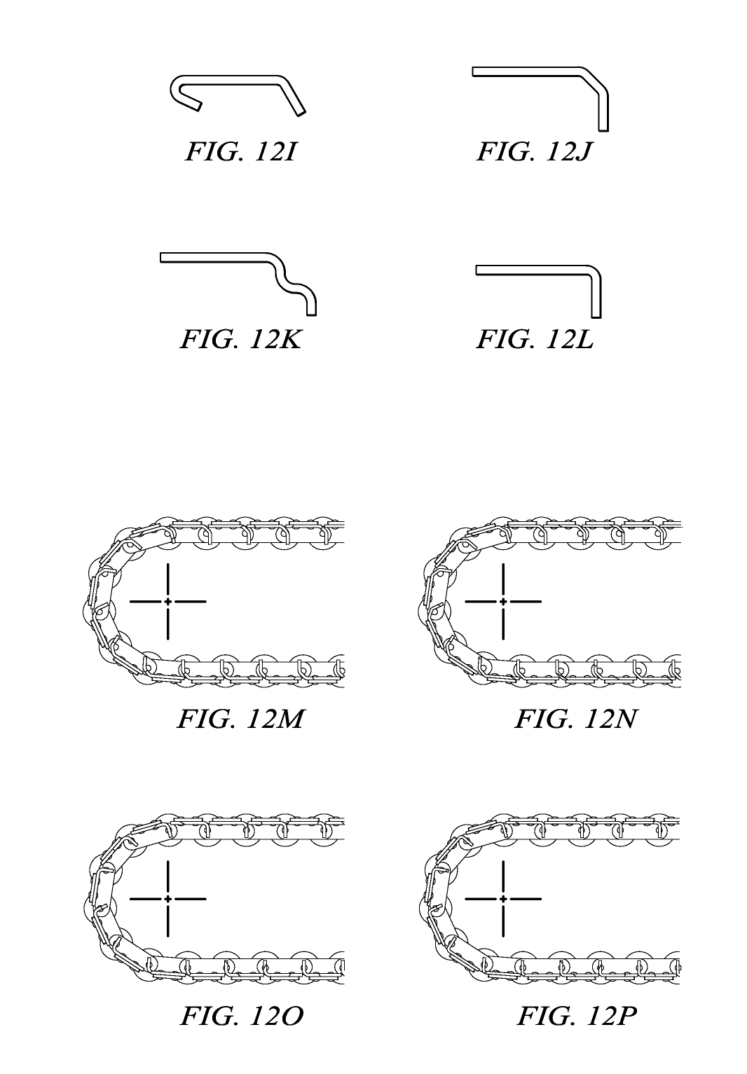

The construction of the hybrid chains comprising the conveyor 60 is illustrated in FIG. 12. Each chain comprises stainless steel bushings 80 and stainless steel pins 82. The plates 84, the rollers 86 and the plates 88 comprise carbon steel. Alternatively, the chain 60 can comprise a lubrication-free construction wherein each pin is coated with a solid lubricant, and/or the bushing is an oil impregnated sintered material, and/or the chain incorporates high temperature seals and employs a high temperature grease or solid lubricant at the bushing/pin interface. The construction of the hybrid chain provides the strength of carbon (hence the carbon plates), but the better high temperature wear resistance of stainless steel (hence the stainless steel pins and bushings. Alternatively, different material/alloy combinations that better match the coefficient of thermal expansion of the chain, such as HASTELLOY®, INCALOY®, M50, H13 or other high temperature tool steels can be used in the practice of the invention.

The tracks 42 which support and guide the conveyor 60 can be heat treated. When the conveyor 60 comprises a lubrication-free construction the tracks 42 are preferably provided with solid lubrication on at least the upper surface thereof.

FIGS. 12A and 12B illustrate a first alternative design and FIGS. 12C and 12D illustrate a second alternative design for the conveyor 60 of FIG. 12. FIGS. 12A and 12D illustrate the top or baking sides of the conveyors and FIGS. 12B and 12C illustrate the return sides. The alternative chain designs illustrated in FIGS. 12A and 12B and in FIGS. 12C and 12D, respectively, separate the tortilla supporting members of the chain from the structural components of the tortilla oven 30, thereby negating the possibility of interference between the chain and the structural components which can damage the chain and thereby necessitate shut down of the tortilla oven 30 to facilitate repairs. An advantage resulting from the use of either the first alternative design or the second alternative design is that the tracks or runners for the first and second alternative designs need not be machined.

FIGS. 12E through 12L, inclusive, comprise end views of various slat designs that can be utilized in the conveyor 60. Each of the slat designs shown in FIGS. 12F through 12M, inclusive, comprises a nominally horizontal tortilla supporting section and at least two bends and a depending section that stiffens the slat and prevents bending, warping, and buckling. The slats may be formed either from an appropriate metal or from a plastic material that is designed to withstand the temperatures experienced within the tortilla oven 30. The conveyor 60 can also be manufactured from one or more plastic, ceramic, and/or composite materials. The use of non-metallic components in the fabrication of the conveyor 60 can provide advantages including higher thermal conductivity and reduced thermal mass thereby causing the oven to heat up and cool down more rapidly and more uniformly.

FIG. 12M illustrates the slat design of FIG. 12J in a relatively small pitch conveyor 60 and FIG. 12N illustrates the use of the slat design of FIG. 12J in a relatively large pitch conveyor 60. FIG. 12O illustrates the slat design of FIG. 12L utilized in a relatively small pitch conveyor 60 and FIG. 12P illustrates the use of the slat design of FIG. 12L in a relatively large pitch conveyor 60.

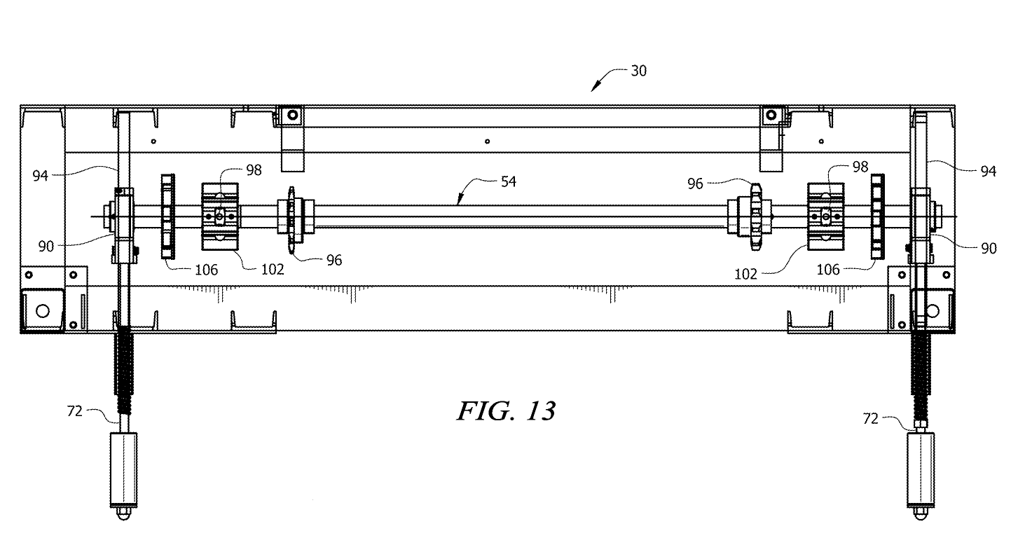

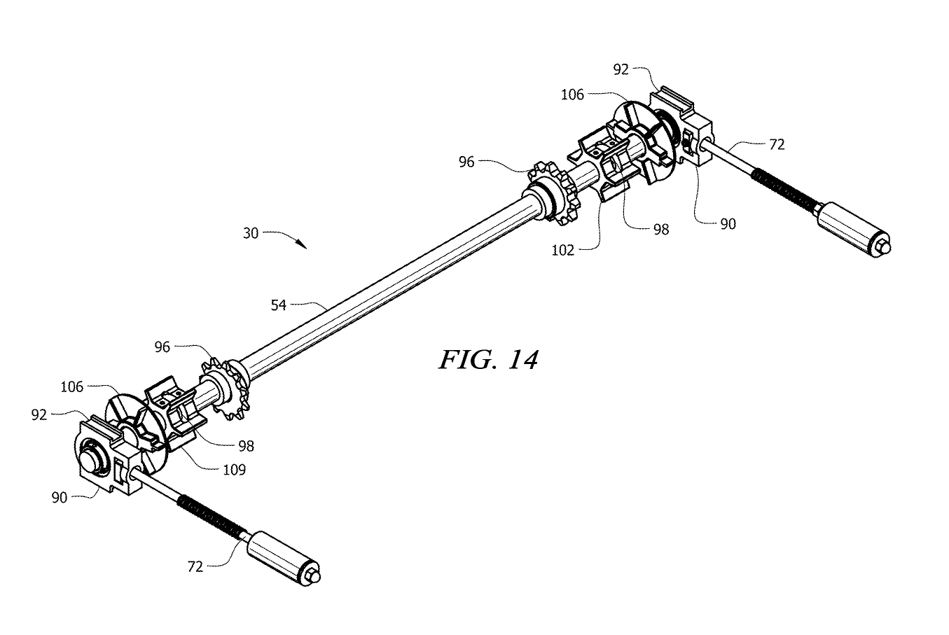

The construction and operation of the shafts 54 comprising the tortilla oven 30 is further illustrated in FIGS. 13-20 inclusive. The rods 72 extend from bearing blocks 90 which rotatably support the shafts 54. As shown in FIG. 14 the bearing blocks 90 have slideways 92 formed integrally therewith. The slideways 92 engaged guides 94 thereby facilitating longitudinal movement of the shafts 54 as the conveyors 60 expand and contract depending upon the temperature within the tortilla oven 30.

The shafts 54 comprise sprockets 96 which engage and guide the conveyor 60. Referring particularly to FIGS. 16 and 17 portions 98 of the shafts 54 located between the sprockets 96 and the slideways 92 have holes 100 drilled therethrough to limit heat transfer axially along the lengths of the shafts 54. The portions of the shafts 54 having the holes 100 drilled therethrough are reinforced with rings 102 which are in turn provided with heat dissipating fins 104. In this manner the elevated temperatures of the sections of the shafts 54 extending between the sprockets 96 which occur during operation of the tortilla oven 30 are not transferred to the bearings located within the bearing blocks 90 which rotatably support the shafts 54. Fans 106 mounted on the shafts 54 between the portions 98 thereof having the holes 100 drilled therethrough and the bearing blocks 90 further limit heat transfer from the center sections of the shafts 54 to the end portions thereof and to the bearings which rotatably support the shafts 54. In lieu of the holes 100 the shafts 54 may be provided with additional fans 106 in accordance with the requirements of particular embodiments or the invention.

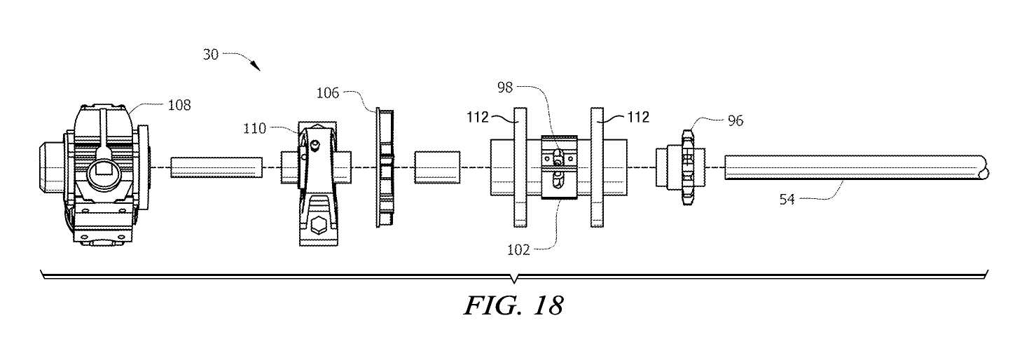

The construction and operation of the shafts 54 of the tortilla oven 30 are further illustrated in FIGS. 18, 19, and 20. Each shaft 54 is actuated by a drive motor 108. The bearings located at the end of the shaft 54 remote from the drive motor 108 are provided with half dog connections 114 which accommodate thermal expansion of the shaft 54 in the axial direction, it being understood that both ends of each shaft 54 may be provided with half dog connections, depending upon the requirements of particular applications of the invention. The sections 98 of the shafts 54 having the holes 100 have sections of thermal insulating material 112 extending on either side thereof. A double wall of insulation is disposed around the shaft coupler 102 to keep temperatures low.

Alternatively, the shafts 54 of the tortilla oven 30 may be constructed as shown and described in U.S. Provisional Patent Application No. 60/896,027 filed Mar. 21, 2007 and assigned to the Assignee hereof, the disclosure of which is incorporated herein by reference. The shafts 54 may also be constructed as shown and described in U.S. Provisional Patent Application No. 60/975,642 filed Sep. 27, 2007 and assigned to the Assignee hereof, the disclosure of which is incorporated herein by reference.

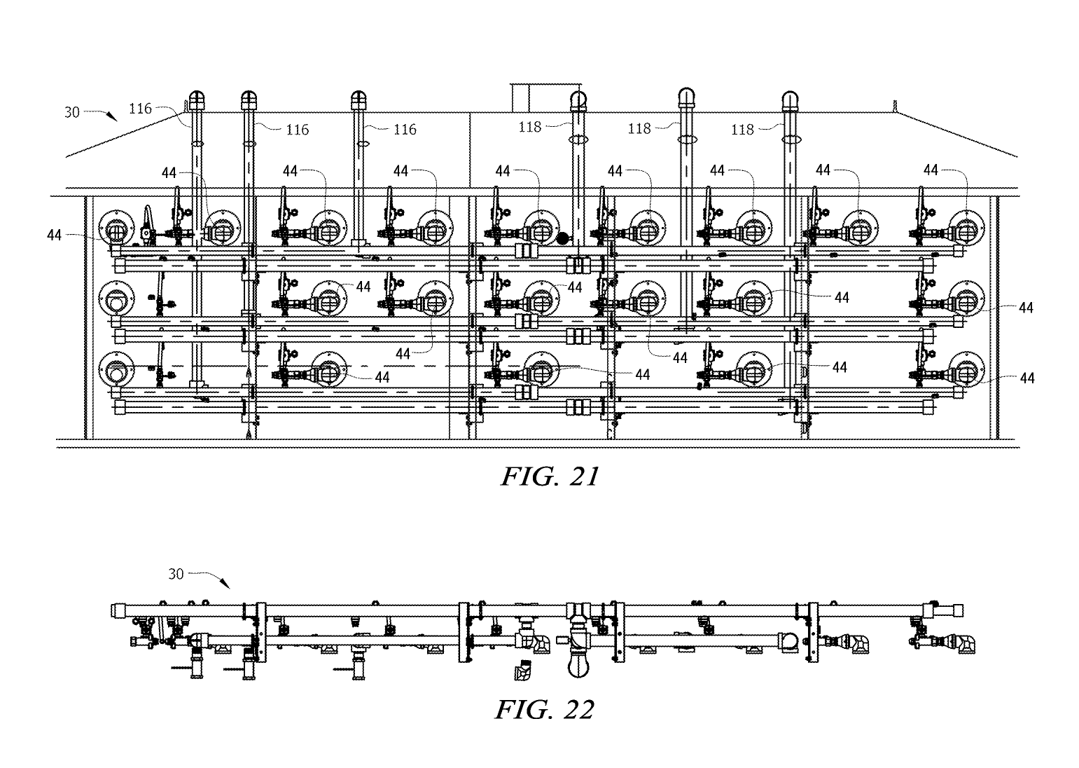

FIGS. 21, 22, and 23 further illustrate the operation of the burners 44 of the tortilla oven 30. Gas is fed into the tortilla oven 30 through pipes 116. Air is fed into the burners 44 though pipes 118. The gas and the air are premixed and are directed through the feed points 46 into a feed control system which individually monitors every burner flame for flame management. This is advantageous in reducing the risk of down time because individual burner failure and burner flame outs can be prevented. Each burner can be individually shut off through the control system for flame profile adjustment and for a greater system capacity turn down ratio. The control system also facilitates management of each of the three zones in the system for control of energy output.

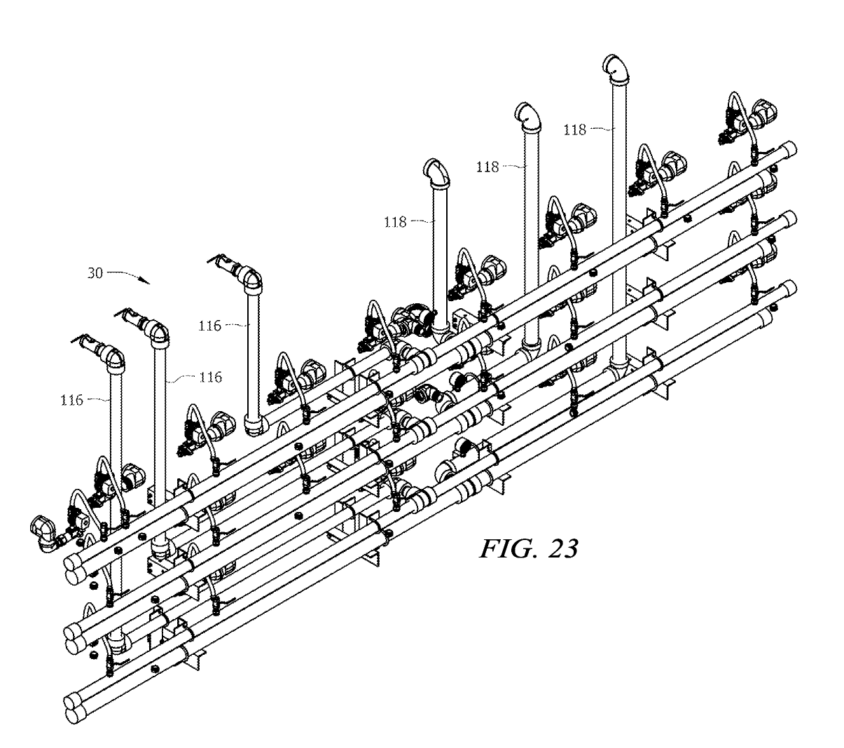

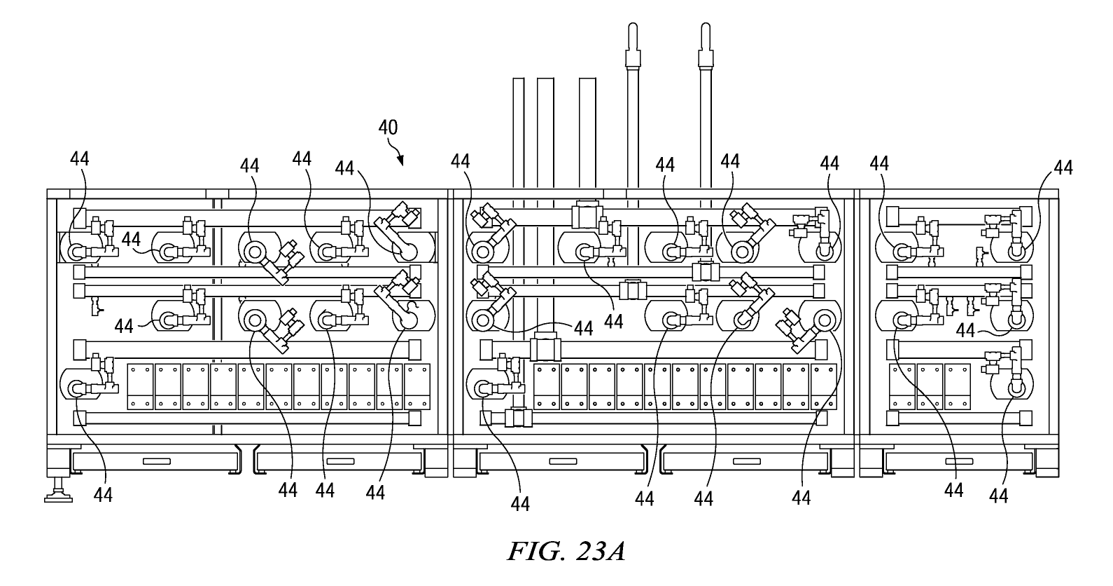

FIG. 23A illustrates an alternative construction of the burners 44 of the tortilla oven 30. In accordance with the alternative construction, the burners 44 are supported for rotation about their respective longitudinal axes, thereby positioning the flames generated by operation of the burners to provide controlled heat transfer to tortillas being transported through the tortilla oven 30 by the conveyor 60.

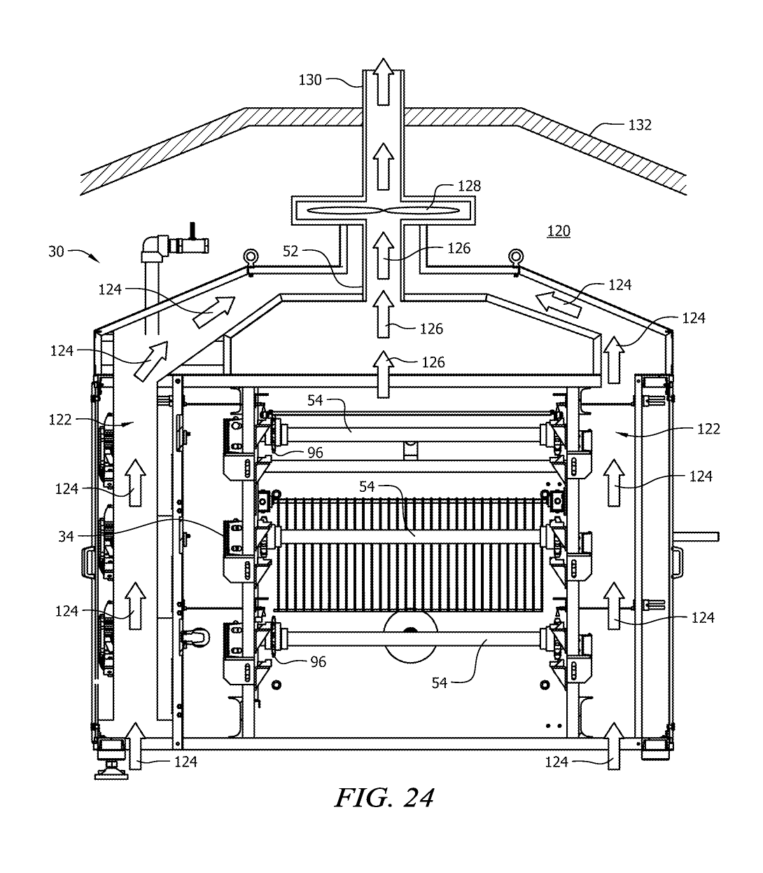

Referring to FIG. 24, atmospheric air is directed along the sides of the baking section 34 of the tortilla oven 30 for purposes of temperature control, minimization of heat transfer into the interior of the building 120 which houses the tortilla oven 30, and to keep the electronics cool. The temperature controlling air moves upwardly through passageways 122 as indicated by the arrows 124. Products of combustion resulting from operation of the tortilla oven 30 move upwardly through one or more outlets 52 as indicated by the arrows 126. The air moving upwardly through the passageways 122 and the products of combustion moving upwardly through the outlet(s) 52 are combined by a fan 128 and are discharged to the atmosphere through one or more outlets 130 extending through the roof 132 of the building 120.

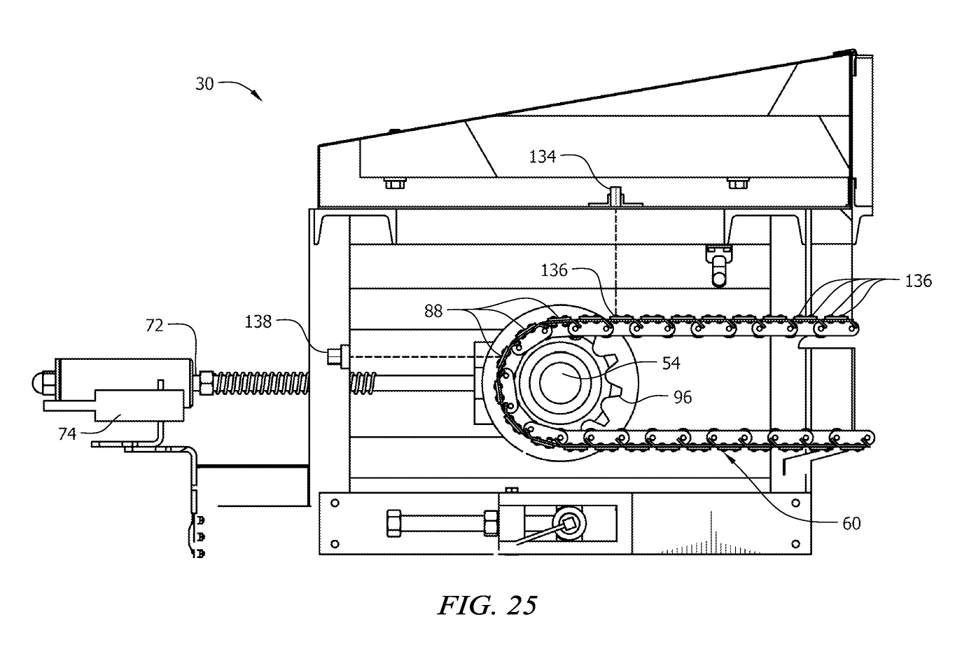

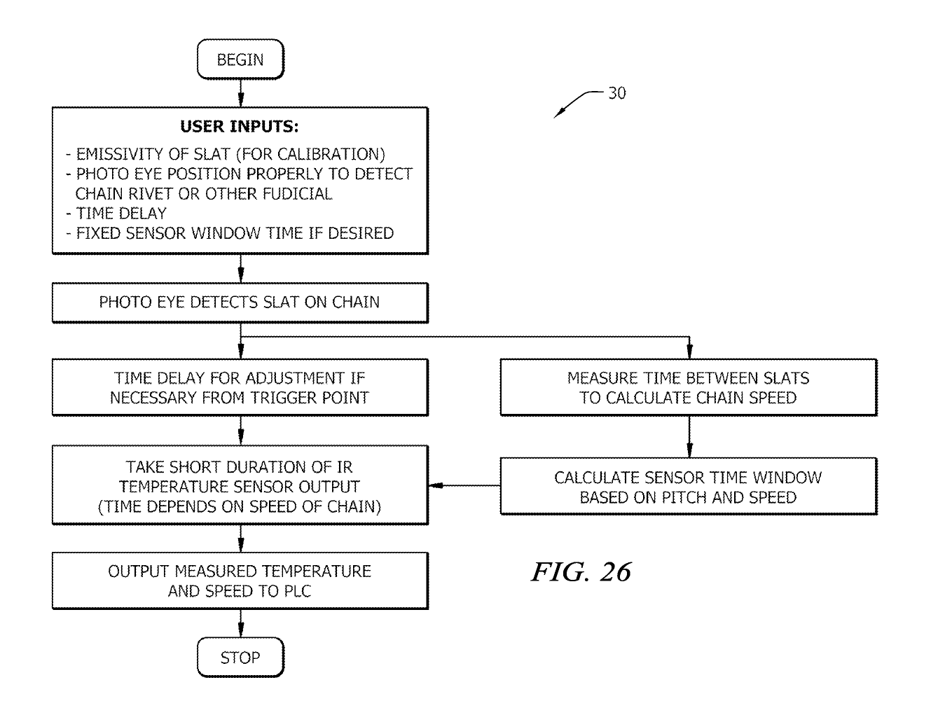

FIG. 25 illustrates a system for monitoring the temperature of each conveyor 60 comprising the tortilla oven 30. It has been determined that continuous monitoring of the temperature of the chain produces an inaccurate result due primarily to erroneous readings which occur when the gaps in the conveyor 60 come into alignment with the temperature sensor. In accordance with the present invention a sensor 134 recognizes the presence of a rivet 136 comprising the conveyor 60. Whenever a rivet 136 is detected by the sensor 134 a slat 88 is aligned with an IR sensor 138. Responsive to a signal from the sensor 134 the sensor 138 takes a virtually instantaneous reading which is not distorted due to the presence of a gap between the plates 88 coming into alignment with the beam of the sensor 138. Operation of the temperature sensor system illustrated in FIG. 25 is further described in the flow chart comprising FIG. 26.

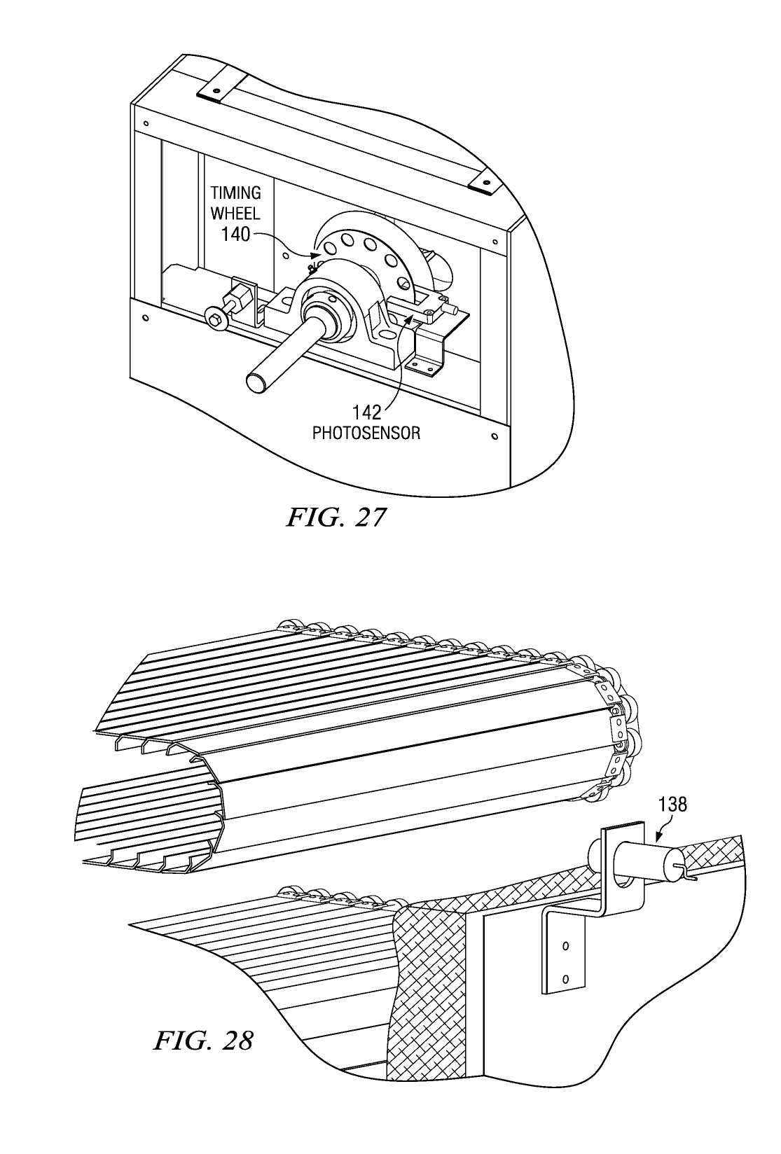

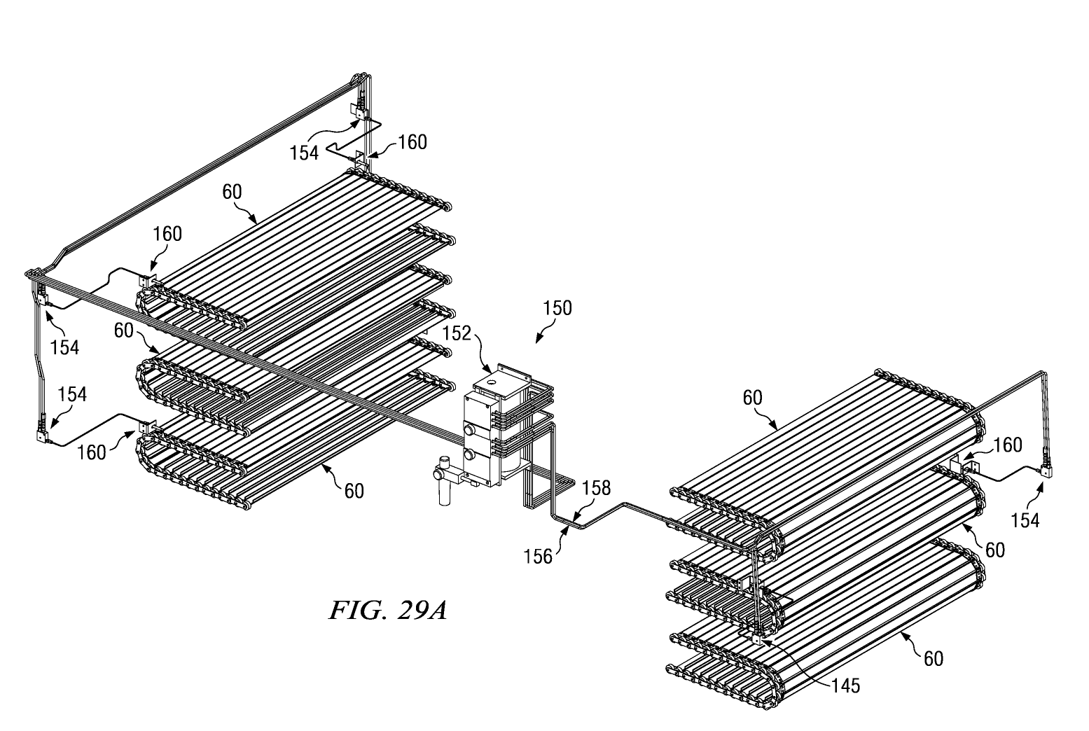

An alternative system for temperature monitoring is shown in FIGS. 27 and 28. A timing wheel 140 is secured to the sprocket 96, or to the shaft 54, such that a photo sensor 142 or other sensor emits a signal when a slat 88 is perpendicular to the IR sensor 138.

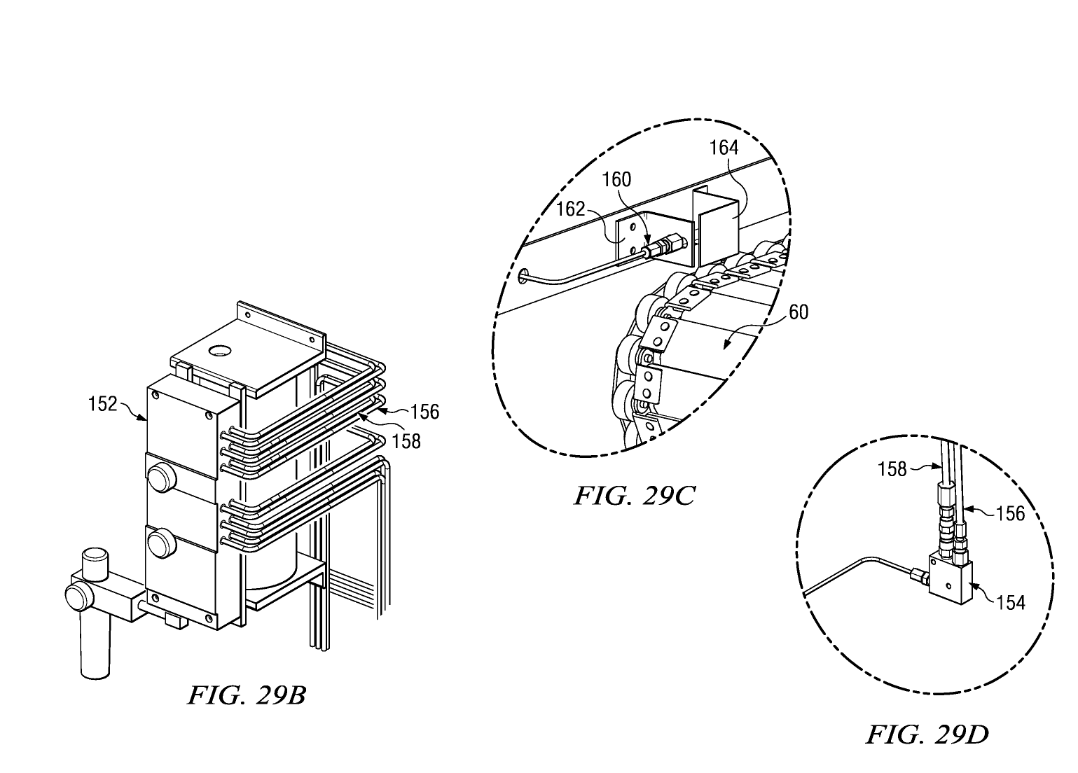

FIGS. 29A, 29B, 29C and 29D illustrate a chain lubrication system 150 useful in the practice of the invention. An actuator 152 delivers a mixture of oil and air to a plurality of mixing devices 154 through separate lines 156 and 158. Mixing devices 154 combine the oil and air in an appropriate ratio and then deliver the oil/air mixture to a plurality of discharge nozzles 160. Alternatively, unmixed oil can be delivered to the discharge nozzles 160. The discharge nozzles 160 direct lubricant onto the chains comprising the conveyor 60 as illustrated in FIGS. 29A and 29C. The chain lubrication system 150 assures that all sections of the conveyor 60 are lubricated equally. Mounting brackets 162 and splash guards 164 prevent oil from contacting the slats 88 while assuring that the pin/bushing interfaces of the conveyor 60 are properly lubricated.

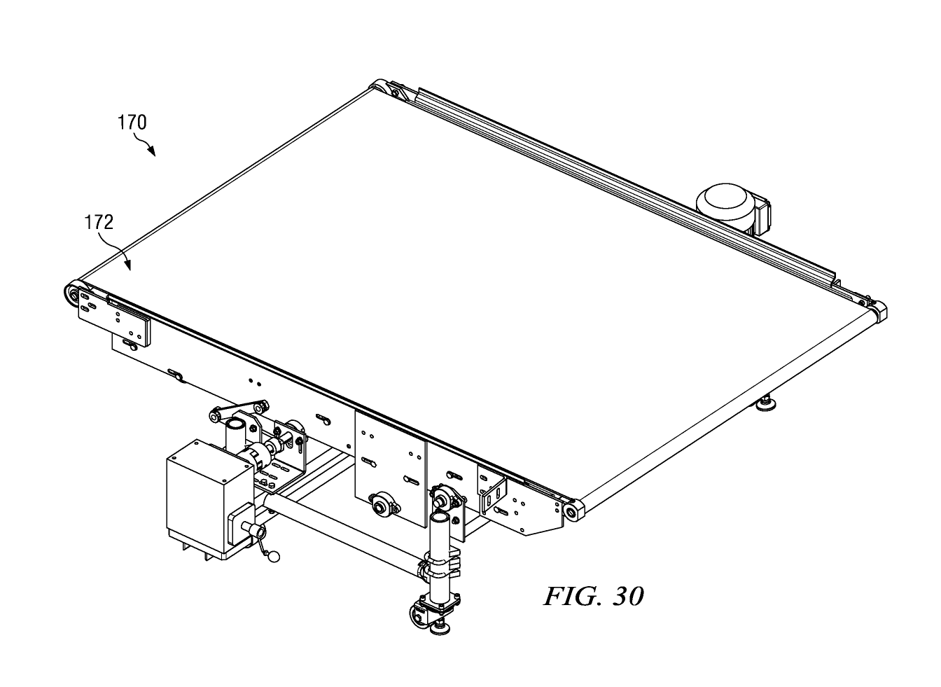

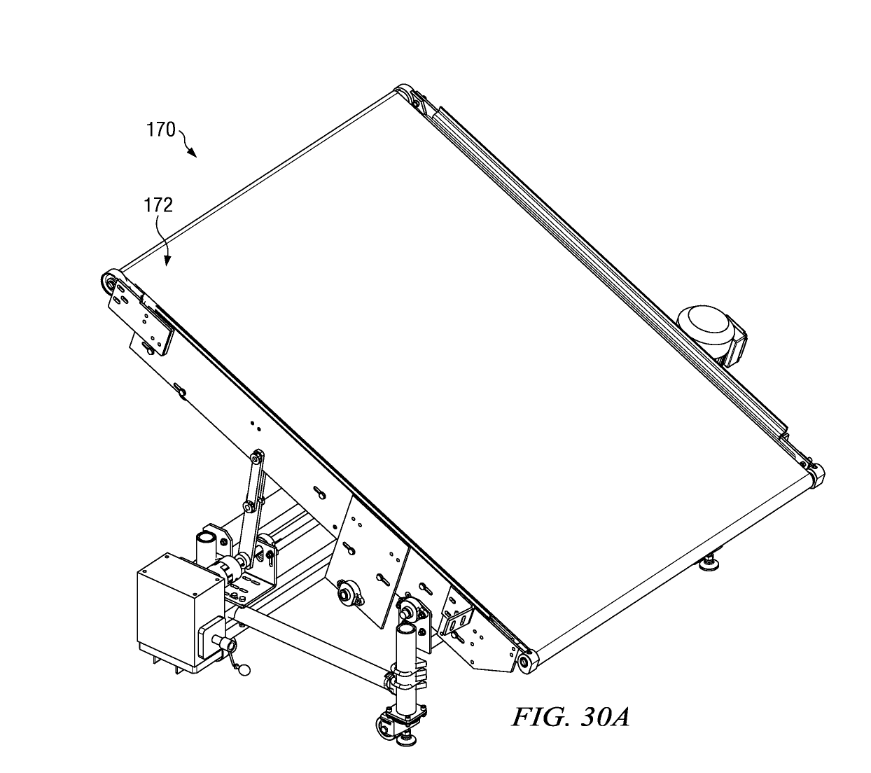

FIGS. 30 and 30A illustrate a discharge conveyor 170 useful in the practice of the invention. FIG. 30 illustrates the discharge conveyor 170 in its operational configuration wherein the infeed end 172 of the conveyor 170 extends horizontally into the discharge end of the tortilla oven 30. FIG. 30A illustrates the conveyor in a tilted configuration wherein the infeed end 172 extends at a substantial angle relative to horizontal. When the conveyor 170 is in the tilted orientation illustrated in FIG. 30A, removal of the conveyor 170 from a tortilla manufacturing system including the tortilla oven 30 is facilitated.

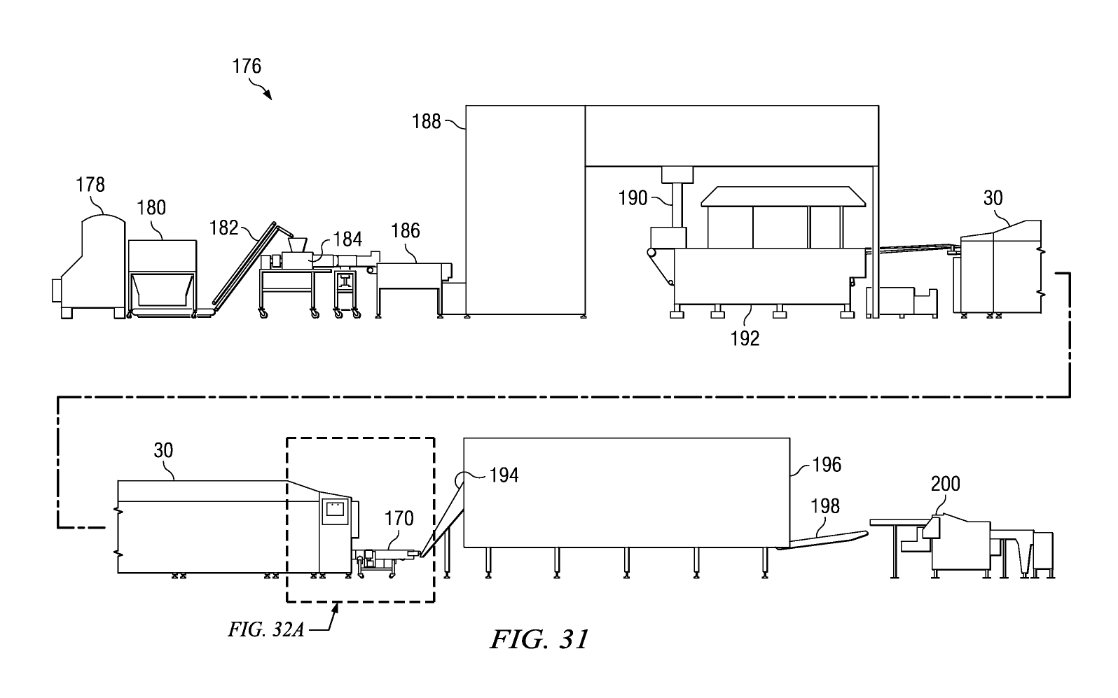

FIG. 31 comprises a schematic illustration of a complete tortilla manufacturing system 176. The ingredients necessary to prepare tortillas are received in a dough mixer 178. A large mass of tortilla dough is transferred from the dough mixer 178 to a dough chunker 180 which divides the large dough mass into relatively small quantities of dough each comprising a quantity of dough sufficient to form approximately eight tortillas. The relatively small quantities of dough transported by a squeeze conveyor 182 and are delivered to a dough divider 184 which further divides the dough into individual quantities each sufficient to form a single tortilla. From the dough divider the small quantities of tortilla dough are delivered to a dough rounding table 186 which delivers rounded dough balls to an overhead proofer 188.

From the overhead proofer 188 the proofed dough balls are directed through a dough ball drop 190. From the dough ball drop 190 the dough balls are received in a tortilla press 192 which forms dough balls into the conventional flat, circular tortilla shape. From the tortilla press 192 the formed, but unbaked tortillas are directed into the tortilla oven 30 of the present invention. The tortilla oven 30 functions to bake the tortillas in the manner described hereinabove. From the tortilla oven 30 the tortillas are received on the discharge conveyor 170 of the present invention which delivers the tortillas to a vacuum incline conveyor 194. The vacuum incline conveyor 194 directs the tortillas into a cooler 196 which may comprise ambient air cooling, forced air cooling, or refrigerated air cooling. From the cooler 196 the tortillas may be directed across an optional visual inspection station 198. Regardless of whether the visual inspection 198 is employed the tortillas are ultimately directed into a counter, stacker and wrapper assembly 200.

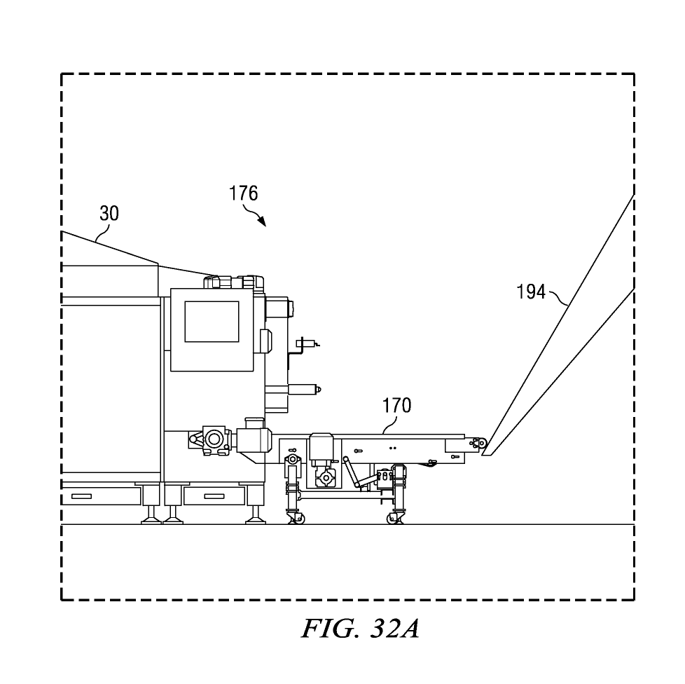

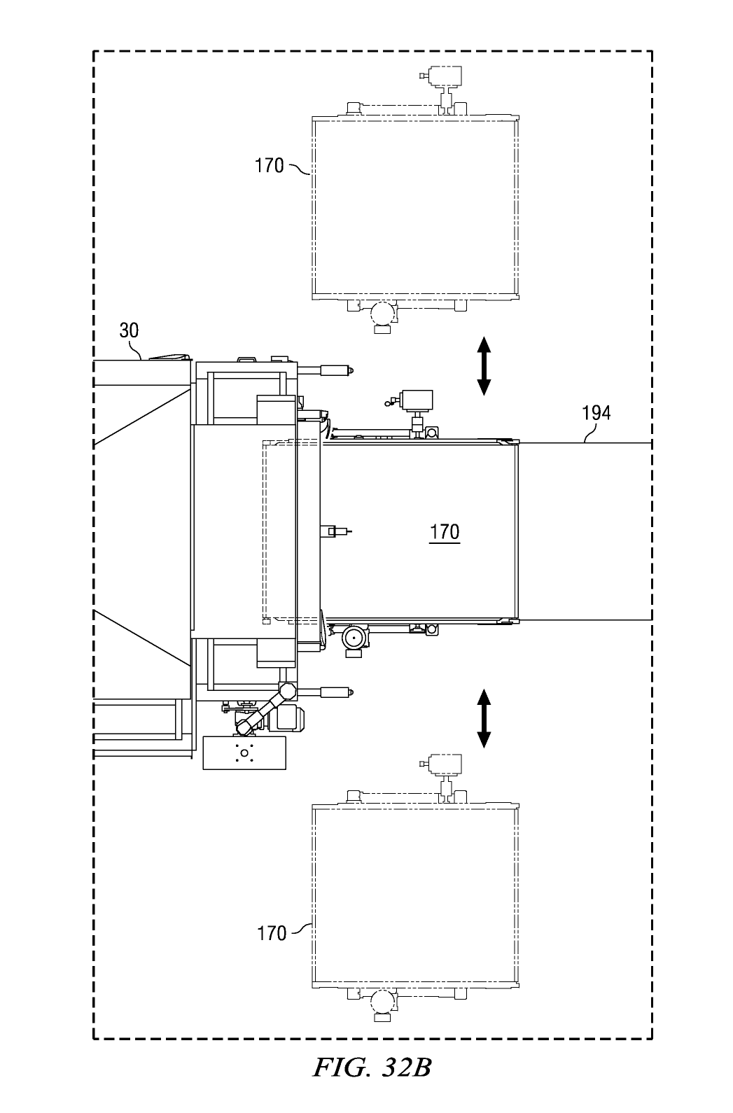

FIG. 32A illustrates the conveyor 170 in its operational relationship with respect to the tortilla oven 30 and the vacuum incline conveyor 194. As will be apparent, when the conveyor 170 is oriented horizontally removal of the conveyor 170 for cleaning is virtually impossible. In accordance with the present invention, the conveyor 170 can be tilted into an angular orientation thereby facilitating removal of the conveyor 170 from the tortilla oven 30.

FIG. 32B illustrates the conveyor 170 in its operating configuration in full lines and in its tilted removable configuration in dashed lines.

Although the invention has been described with reference to illustrative embodiments, the foregoing description is not intended to limit the scope of the invention. Various modifications and combinations of the illustrative embodiments as well as other embodiments of the invention will be apparent to persons skilled in the art upon reference to the description. It is therefore intended that the appended claims incorporate any such modifications or embodiments.

1. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the means for heating the interior of the oven enclosure comprising a plurality of tubular burners each having an axis and each extending perpendicularly with respect to and beneath the predetermined path; and
means for supporting each tubular burner for rotation about its axis and thereby controlling the baking of the tortillas.

2. The tortilla oven according to claim 1 wherein:
the conveyor means comprises a plurality of tortilla supporting slats;
wherein adjacent slats are separated from one another by predetermined intervals; and
means for determining the operating temperature of the oven comprising means for measuring the temperature of the slats of the conveyor means without measuring the temperature of the intervals between the slats.

3. The tortilla oven according to claim 2 therein the slats comprise a metal.

4. The tortilla oven according to claim 2 wherein the slats comprise a plastic.

5. The tortilla oven according to claim 2 further characterized by timing means for actuating the operating temperature determining means when a conveyor slat is in a predetermined orientation and for disabling the operating temperature determining means when no conveyor slat is in the predetermined orientation.

6. The tortilla oven according to claim 5 wherein the timing means comprises means responsive to the location of a component of the chain.

7. The tortilla oven according to claim 5 wherein the timing means comprises a timing wheel and means for rotating the timing wheel in accordance with the speed of operation of the chain.

8. The tortilla oven according to claim 1 wherein:
the conveyor comprises an endless loop having an elongated oval configuration defined by opposed ends;
wherein the conveyor is supported by shafts which engage the conveyor at the closed ends thereof; and
wherein the conveyor supporting shafts comprise heat dissipating shafts.

9. The tortilla oven according to claim 8 wherein each of the shafts is individually removable from the tortilla oven.

10. The tortilla oven according to claim 1 further including a thermally insulated container positioned below the conveyor means for receiving debris generated by operation of the tortilla oven.

11. A tortilla oven comprising:
an oven enclosure defining an interior;
the interior of the oven enclosure comprising an upper heated zone and a lower non-heated zone;
first conveyor means located within the upper heated zone of the interior oven enclosure for receiving unbaked tortillas and for initially transporting tortillas through the heated upper zone of the oven enclosure;
second conveyor means located within the upper heated zone of the oven enclosure for receiving tortillas from the first conveyor means and for continuing the transport of the tortillas through the upper heated zone of the oven enclosure whereby the tortillas are baked; and
third conveyor means located within the lower non-heated zone of the oven interior for receiving baked tortillas from the second conveyor means and for transporting the baked tortillas through the non-heated lower zone of the oven interior thereby initially cooling the baked tortillas.

12. The tortilla oven according to claim 11 wherein each of the conveyors comprises an endless loop having an elongated oval configuration defined by opposed ends;
wherein each of the conveyors is supported by shafts which engage the conveyor at the opposed ends thereof;
wherein the shafts located at the opposed ends of the first and second conveyors comprise heat dissipating shafts; and
wherein each of the shafts is individually removable from the oven.

13. The tortilla oven according to claim 11 wherein:
at least the first and second conveyor means comprise a plurality of tortilla supporting slats;
each of the slats comprising a supporting section, at least two bends, and a depending section for preventing bending of the slat.

14. The tortilla oven according to claim 13 wherein the slats comprise a metal.

15. The tortilla oven according to claim 13 wherein the slats comprise a plastic.

16. The tortilla oven according to claim 15 wherein each of the conveyors is constructed entirely from plastic components.

17. The tortilla oven according to claim 13 wherein:
adjacent slats are separated from one another by predetermined intervals; and
means for determining the operating temperature of the oven comprising means for measuring the temperature of the slats of the conveyor means without measuring the temperature of the intervals between the slats.

18. The tortilla oven according to claim 17 further characterized by timing means for actuating the operating temperature determining means when a conveyor slat is in a predetermined orientation and for disabling the operating temperature determining means when no conveyor slat is in the predetermined orientation.

19. The tortilla oven according to claim 18 wherein the timing means comprises means responsive to the location of a component of the claim.

20. The tortilla oven according to claim 18 wherein the timing means comprises a timing wheel and means for rotating the timing wheel in accordance with the speed of operation of the chain.

21. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the conveyor comprising an endless loop having an elongated oval configuration defined by opposed ends;
two heat dissipating shafts which engage the conveyor at the closed ends thereof and support the conveyor for travel around a predetermined course comprising a horizontally disposed upper tortilla transporting section and a lower return portion.

22. The tortilla oven according to claim 21 wherein each of the shafts is individually removable from the tortilla oven.

23. The tortilla oven according to claim 21 wherein:
the conveyor means comprises a plurality of tortilla supporting slats;
wherein adjacent slats are separated from one another by predetermined intervals; and
the means for determining the operating temperature of the oven comprising means for measuring the temperature of the slats of the conveyor means without measuring the temperature of the intervals between the slats.

24. The tortilla oven according to claim 23 therein the slats comprise a metal.

25. The tortilla oven according to claim 23 wherein the slats comprise a plastic.

26. The tortilla oven according to claim 21 further characterized by timing means for actuating the operating temperature determining means when a conveyor slat is in a predetermined orientation and for disabling the operating temperature determining means when no conveyor slat is in the predetermined orientation.

27. The tortilla oven according to claim 26 wherein the timing means comprises means responsive to the location of a component of the chain.

28. The tortilla oven according to claim 26 wherein the timing means comprises a timing wheel and means for rotating the timing wheel in accordance with the speed of operation of the chain.

29. The tortilla oven according to claim 21 wherein the means for heating the interior of the oven enclosure comprises:
a plurality of tubular burners each having an axis and each extending perpendicularly with respect to and beneath the horizontally disposed upper tortilla transporting section of the predetermined course; and
means for supporting each tubular burner for rotation about its axis and thereby controlling the baking of the tortillas.

30. The tortilla oven according to claim 21 further including a thermally insulated container positioned below the conveyor means for receiving debris generated by operation of the tortilla oven.

31. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
a double wall exhaust conduit for removing products of combustion from the interior of the oven; and
means for directing air through the space between the double walls of the exhaust conduit for cooling the exterior of the tortilla oven.

32. The tortilla oven according to claim 31 wherein:
the conveyor means comprises a plurality of tortilla supporting slats;
wherein adjacent slats are separated from one another by predetermined intervals; and
means for determining the operating temperature of the oven comprising means for measuring the temperature of the slats of the conveyor means without measuring the temperature of the intervals between the slats.

33. The tortilla oven according to claim 32 further characterized by timing means for actuating the operating temperature determining means when a conveyor slat is in a predetermined orientation and for disabling the operating temperature determining means when no conveyor slat is in the predetermined orientation.

34. The tortilla oven according to claim 31 wherein:
the conveyor means comprises a plurality of substantially equally spaced slats for supporting tortillas during transport through the oven enclosure;
each of the slats comprising a tortilla supporting section, at least two bends, and a depending section extending angularly relative to the supporting section for preventing ending of the slat.

35. The tortilla oven according to claim 34 therein the slats comprise a metal.

36. The tortilla oven according to claim 34 wherein the slats comprise a plastic.

37. The tortilla oven according to claim 31 wherein:
the conveyor comprises an endless loop having an elongated oval configuration defined by opposed ends;
wherein the conveyor is supported by shafts which engage the conveyor at the closed ends thereof; and
wherein the conveyor supporting shafts comprise heat dissipating shafts.

38. The tortilla oven according to claim 31 wherein the means for heating the interior of the oven enclosure comprises:
a plurality of tubular burners each having an axis and each extending perpendicularly with respect to and beneath the predetermined path; and
means for supporting each tubular burner for rotation about its axis and thereby controlling the baking of the tortillas.

39. The tortilla oven according to claim 31 further characterized by:
the interior of the oven enclosure comprising an upper heated zone and a lower non-heated zone;
first conveyor means located within the upper heated zone of the interior oven enclosure for receiving unbaked tortillas and for initially transporting tortillas through the heated upper zone of the oven enclosure;
second conveyor means located within the upper heated zone of the oven enclosure for receiving tortillas from the first conveyor means and for continuing the transport of the tortillas through the upper heated zone of the oven enclosure whereby the tortillas are baked; and
third conveyor means located within the lower non-heated zone of the oven interior for receiving baked tortillas from the second conveyor means and for transporting the baked tortillas through the non-heated lower zone of the oven interior thereby initially cooling the baked tortillas.

40. The tortilla oven according to claim 31 further including a thermally insulated container positioned below the conveyor means for receiving debris generated by operation of the tortilla oven.

41. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the conveyor means comprising a plurality of tortilla supporting slats that are separated from one another by predetermined intervals; and
means for determining the operating temperature of the oven comprising means for measuring the temperature of the slats of the conveyor means without measuring the temperature of the intervals between the slats.

42. The tortilla oven according to claim 41 therein the slats comprise a metal.

43. The tortilla oven according to claim 41 wherein the slats comprise a plastic.

44. The tortilla oven according to claim 41 further characterized by timing means for actuating the operating temperature determining means when a conveyor slat is in a predetermined orientation and for disabling the operating temperature determining means when no conveyor slat is in the predetermined orientation.

45. The tortilla oven according to claim 44 wherein the timing means comprises means responsive to the location of a component of the chain.

46. The tortilla oven according to claim 44 wherein the timing means comprises a timing wheel and means for rotating the timing wheel in accordance with the speed of operation of the chain.

47. The tortilla oven according to claim 41 wherein:
the means for heating the interior of the oven enclosure comprises a plurality of tubular burners each having an axis and each extending perpendicularly with respect to and beneath the predetermined path; and
means for supporting each tubular burner for rotation about its axis and thereby controlling the baking of the tortillas.

48. The tortilla oven according to claim 41 further comprising a double wall exhaust conduit for removing products of combustion from the interior of the oven; and
means for directing air through the space between the double walls of the exhaust conduit for cooling the exterior of the tortilla oven.

49. The tortilla oven according to claim 41 wherein:
the conveyor comprises an endless loop having an elongated oval configuration defined by opposed ends; and
two heat dissipating shafts which engage the conveyor at the closed ends thereof and support the conveyor for travel around a predetermined course comprising a horizontally disposed upper tortilla transporting portion and a lower return portion.

50. The tortilla oven according to claim 49 wherein the heat dissipating shafts are individually removable from the tortilla oven.

51. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the conveyor comprising an endless loop having an elongated oval configuration defined by opposed ends;
two independently removable shafts which engage the conveyor at the closed ends thereof and support the conveyor for travel around a predetermined course comprising a horizontally disposed upper tortilla transporting portion and a lower return portion.

52. The tortilla oven according to claim 51 wherein:
the conveyor means comprises a plurality of tortilla supporting slats;
wherein adjacent slats are separated from one another by predetermined intervals; and
the means for determining the operating temperature of the oven comprising means for measuring the temperature of the slats of the conveyor means without measuring the temperature of the intervals between the slats.

53. The tortilla oven according to claim 52 therein the slats comprise a metal.

54. The tortilla oven according to claim 52 wherein the slats comprise a plastic.

55. The tortilla oven according to claim 52 further characterized by timing means for actuating the operating temperature determining means when a conveyor slat is in a predetermined orientation and for disabling the operating temperature determining means when no conveyor slat is in the predetermined orientation.

56. The tortilla oven according to claim 55 wherein the timing means comprises means responsive to the location of a component of the chain.

57. The tortilla oven according to claim 55 wherein the timing means comprises a timing wheel and means for rotating the timing wheel in accordance with the speed of operation of the chain.

58. The tortilla oven according to claim 51 wherein the means for heating the interior of the oven enclosure comprises:
a plurality of tubular burners each having an axis and each extending perpendicularly with respect to and beneath the horizontally disposed upper tortilla transporting section of the predetermined course; and
means for supporting each tubular burner for rotation about its axis and thereby controlling the baking of the tortillas.

59. The tortilla oven according to claim 51 wherein the independently removable shafts comprise heat dissipating shafts.

60. The tortilla oven according to claim 51 further including a thermally insulated container positioned below the conveyor means for receiving debris generated by operation of the tortilla oven.

61. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the oven enclosure and the conveyor means comprising at least three separable components including opposed end components and at least one center component; and
quick disconnect means for securing the separable components one to another and facilitating disconnection of the components from one another.

62. The tortilla oven according to claim 61 wherein:
the conveyor means comprises a plurality of tortilla supporting slats;
wherein adjacent slats are separated from one another by predetermined intervals; and
the means for determining the operating temperature of the oven comprising means for measuring the temperature of the slats of the conveyor means without measuring the temperature of the intervals between the slats.

63. The tortilla oven according to claim 62 therein the slats comprise a metal.

64. The tortilla oven according to claim 62 wherein the slats comprise a plastic.

65. The tortilla oven according to claim 62 further characterized by timing means for actuating the operating temperature determining means when a conveyor slat is in a predetermined orientation and for disabling the operating temperature determining means when no conveyor slat is in the predetermined orientation.

66. The tortilla oven according to claim 65 wherein the timing means comprises means responsive to the location of a component of the chain.

67. The tortilla oven according to claim 65 wherein the timing means comprises a timing wheel and means for rotating the timing wheel in accordance with the speed of operation of the chain.

68. The tortilla oven according to claim 61 wherein:
the conveyor comprises an endless loop having an elongated oval configuration defined by opposed ends;
wherein the conveyor is supported by shafts which engage the conveyor at the closed ends thereof; and
wherein the conveyor supporting shafts comprise heat dissipating shafts.

69. The tortilla oven according to claim 68 wherein each of the shafts is individually removable from the tortilla oven.

70. The tortilla oven according to claim 61 further comprising a double wall exhaust conduit for removing products of combustion from the interior of the oven; and
means for directing air through the space between the double walls of the exhaust conduit for cooling the exterior of the tortilla oven.

71. A tortilla oven comprising:
an oven enclosure defining an interior;
first conveyor means located within the interior of the oven enclosure for receiving unbaked tortillas and for initially transporting tortillas through the oven enclosure whereby the tortillas partially baked;
second conveyor means located within the interior of the oven enclosure for receiving tortillas from the first conveyor means and for continuing the transport of the tortillas through the oven enclosure whereby the tortillas are further baked; and
third conveyor means located within the oven interior for receiving baked tortillas from the second conveyor means and for transporting the baked tortillas through the oven interior whereby the baking of the tortillas is completed; and
means for automatically and uniformly lubricating the first, second and third conveyor means.

72. The tortilla oven according to claim 71 wherein the means for lubricating the first, second and third conveyor means comprises means for lubricating each of the conveyor means at the same predetermined pressure.

73. The tortilla oven according to claim 72 further comprising means for containing overspray resulting from the operation of the means for lubricating the first, second and third conveyor means.

74. The tortilla oven according to claim 71 wherein each of the first, second and third conveyor means comprises an endless loop having an elongated oval configuration defined by opposed ends;
wherein each of the first, second and third conveyor means is supported by shafts which engage the conveyor at the closed ends thereof; and
wherein the shafts located at the opposed ends of the first, second and third conveyor means comprise heat dissipating shafts.

75. The tortilla oven according to claim 74 wherein the heat dissipating shafts are individually removable from the tortilla oven.

76. The tortilla oven according to claim 71 wherein:
at least one of the first, second and third conveyor means comprises a plurality of tortilla supporting slats;
wherein adjacent slats are separated from one another by predetermined intervals; and
the means for determining the operating temperature of the oven comprising means for measuring the temperature of the slats of the conveyor means without measuring the temperature of the intervals between the slats.

77. The tortilla oven according to claim 76 further characterized by timing means for actuating the operating temperature determining means when a conveyor slat is in a predetermined orientation and for disabling the operating temperature determining means when no conveyor slat is in the predetermined orientation.

78. The tortilla oven according to claim 77 wherein the timing means comprises means responsive to the location of a component of the chain.

79. The tortilla oven according to claim 77 wherein the timing means comprises a timing wheel and means for rotating the timing wheel in accordance with the speed of operation of the chain.

80. The tortilla oven according to claim 76 wherein each of the slats comprises an integral construction including a nominally horizontally disposed support portion, at least two bends, and a depending motion extending angularly from the support portion for preventing bending of the slat.

81. A tortilla oven comprising:
a housing;
three conveyors mounted within the housing in a vertical array and comprising upper, center, and lower conveyors for transporting tortillas through the oven during baking thereof;
each of the conveyors comprising drive shafts at the opposite ends thereof;
each of the drive shafts including means for preventing heat transfer axially along the length of the drive shaft;
a plurality of burners mounted within the housing and extending through the conveyors for heating the interior of the housing;
means for individually monitoring and regulating the operation of the each burner independently of the other burners comprising the plurality thereof;
means for individually monitoring the response of the each of the three conveyors to the temperature within the housing;
means for individually monitoring the operating temperature of each conveyor;
means for causing ambient air to flow upwardly through the housing and adjacent to the three conveyors mounted therein and thereby regulating the temperature within the housing.

82. The tortilla oven according to claim 81 wherein:
the conveyor means comprises a plurality of tortilla supporting slats;
wherein adjacent slats are separated from one another by predetermined intervals; and
the means for determining the operating temperature of the oven comprising means for measuring the temperature of the slats of the conveyor means without measuring the temperature of the intervals between the slats.

83. The tortilla oven according to claim 82 therein the slats comprise a metal.

84. The tortilla oven according to claim 82 wherein the slats comprise a plastic.

85. The tortilla oven according to claim 82 further characterized by timing means for actuating the operating temperature determining means when a conveyor slat is in a predetermined orientation and for disabling the operating temperature determining means when no conveyor slat is in the predetermined orientation.

86. The tortilla oven according to claim 85 wherein the timing means comprises means responsive to the location of a component of the chain.

87. The tortilla oven according to claim 85 wherein the timing means comprises a timing wheel and means for rotating the timing wheel in accordance with the speed of operation of the chain.

88. The tortilla oven according to claim 81 further comprising a double wall exhaust conduit for removing products of combustion from the interior of the oven; and
means for directing air through the space between the double walls of the exhaust conduit for cooling the exterior of the tortilla oven.

89. The tortilla oven according to claim 81 wherein, each of tubular burners each has an axis that extends perpendicularly with the respect to and beneath one of the conveyors; and
means for supporting each tubular burner for rotation about its axis and thereby controlling the baking of the tortillas.

90. The tortilla oven according to claim 89 wherein each tubular burner is individually removable from the tortilla oven.

91. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the means for heating the interior of the oven enclosure comprising a plurality of tubular burners each having an axis and each extending perpendicularly with respect to and beneath the predetermined path; and
feedback means for monitoring the tension of the conveyor means and for generating a signal wherever the tension of the conveyor means is not within predetermined limits.

92. The tortilla oven according to claim 91 wherein the conveyor means comprises a plurality of conveyors and wherein the feedback means measures the tension of each conveyor comprising the conveyor means.

93. The tortilla oven according to claim 91 wherein:
the conveyor means comprises a plurality of tortilla supporting slats;
wherein adjacent slats are separated from one another by predetermined intervals; and
means for determining the operating temperature of the oven comprising means for measuring the temperature of the slats of the conveyor means without measuring the temperature of the intervals between the slats.

94. The tortilla oven according to claim 93 therein the slats comprise a metal.

95. The tortilla oven according to claim 93 wherein the slats comprise a plastic.

96. The tortilla oven according to claim 93 further characterized by timing means for actuating the operating temperature determining means when a conveyor slat is in a predetermined orientation and for disabling the operating temperature determining means when no conveyor slat is in the predetermined orientation.

97. The tortilla oven according to claim 96 wherein the timing means comprises means responsive to the location of a component of the chain.

98. The tortilla oven according to claim 96 wherein the timing means comprises a timing wheel and means for rotating the timing wheel in accordance with the speed of operation of the chain.

99. The tortilla oven according to claim 91 wherein:
the conveyor comprises an endless loop having an elongated oval configuration defined by opposed ends;
wherein the conveyor is supported by shafts which engage the conveyor at the closed ends thereof; and
wherein the conveyor supporting shafts comprise heat dissipating shafts.

100. The tortilla oven according to claim 99 wherein each of the shafts is individually removable from the tortilla oven.

101. A tortilla oven comprising:
an oven enclosure defining an interior;
means for heating the interior of the oven enclosure;
conveyor means located within the interior of the oven enclosure for receiving unbaked tortillas and for transporting the tortillas through the interior of the oven along a predetermined path whereby the tortillas are baked;
the conveyor means comprising spaced apart conveyor chains and slats supported on the chains for supporting the tortillas during transport thereof through the oven;
the conveyor chains comprising stainless steel bushings, stainless steel pins, carbon steel plates, and carbon steel rollers;
each of the slats comprising a supporting section, at least two bends, and a depending section for preventing bending of the slat.

102. The tortilla oven according to claim 101 wherein:
the conveyor means comprises a plurality of tortilla supporting slats;
wherein adjacent slats are separated from one another by predetermined intervals; and
means for determining the operating temperature of the oven comprising means for measuring the temperature of the slats of the conveyor means without measuring the temperature of the intervals between the slats.

103. The tortilla oven according to claim 101 wherein the conveyor claims do not require lubrication.

104. The tortilla oven according to claim 101 further including tracks for supporting the conveyor claims during movement thereof, and wherein the conveyor supporting tracks are not machined.

105. The tortilla oven according to claim 102 further characterized by timing means for actuating the operating temperature determining means when a conveyor slat is in a predetermined orientation and for disabling the operating temperature determining means when no conveyor slat is in the predetermined orientation.

106. The tortilla oven according to claim 105 wherein the timing means comprises means responsive to the location of a component of the chain.

107. The tortilla oven according to claim 105 wherein the timing means comprises a timing wheel and means for rotating the timing wheel in accordance with the speed of operation of the chain.

108. The tortilla oven according to claim 101 wherein:
the conveyor comprises an endless loop having an elongated oval configuration defined by opposed ends;
wherein the conveyor is supported by shafts which engage the conveyor at the closed ends thereof; and
wherein the conveyor supporting shafts comprise heat dissipating shafts.

109. The tortilla oven according to claim 108 wherein each of the shafts is individually removable from the tortilla oven.

110. The tortilla oven according to claim 101 further including heat treated solid runners for engagement by the rollers of the chain and a solid lubricant coating the entirety of the roller engaging surfaces of the runners.

111. A tortilla oven comprising:
an oven enclosure defining an interior;
the interior of the oven enclosure comprising an upper heated zone and a lower non-heated zone;
first conveyor means located within the upper heated zone of the interior oven enclosure for receiving unbaked tortillas and for initially transporting tortillas through the heated upper zone of the oven enclosure;
second conveyor means located within the upper heated zone of the oven enclosure for receiving tortillas from the first conveyor means and for continuing the transport of the tortillas through the upper heated zone of the oven enclosure whereby the tortillas are baked;
third conveyor means located within the lower non-heated zone of the oven interior for receiving baked tortillas from the second conveyor means and for transporting the baked tortillas through the non-heated lower zone of the oven interior thereby initially cooling the baked tortillas;
a normally horizontally disposed discharge conveyor for receiving baked tortillas from the third conveyor means; and
means for tilting the discharge conveyor into an inclined orientation to facilitate disengagement of the discharge conveyor from the tortilla oven.

112. The tortilla oven according to claim 111 wherein each of the conveyors comprises an endless loop having an elongated oval configuration defined by opposed ends;
wherein each of the conveyors is supported by shafts which engage the conveyor at the opposed ends thereof;
wherein the shafts located at the opposed ends of the first and second conveyors comprise heat dissipating shafts; and
wherein each of the shafts is individually removable from the oven.

113. The tortilla oven according to claim 111 wherein:
at least the first and second conveyor means comprise a plurality of tortilla supporting slats;
each of the slats comprising a supporting section, at least two bends, and a depending section for preventing bending of the slat.

114. The tortilla oven according to claim 113 wherein the slats comprise a metal.

115. The tortilla oven according to claim 113 wherein the slats comprise a plastic.

116. The tortilla oven according to claim 115 wherein each of the conveyors is constructed entirely from plastic components.

117. The tortilla oven according to claim 113 wherein:
adjacent slats are separated from one another by predetermined intervals; and
means for determining the operating temperature of the oven comprising means for measuring the temperature of the slats of the conveyor means without measuring the temperature of the intervals between the slats.

118. The tortilla oven according to claim 117 further characterized by timing means for actuating the operating temperature determining means when a conveyor slat is in a predetermined orientation and for disabling the operating temperature determining means when no conveyor slat is in the predetermined orientation.

119. The tortilla oven according to claim 118 wherein the timing means comprises means responsive to the location of a component of the claim.

120. The tortilla oven according to claim 118 wherein the timing means comprises a timing wheel and means for rotating the timing wheel in accordance with the speed of operation of the chain.
